(19) United States
(12) Patent Application Publication
(10) Pub. No.: US 2003/0217000 A1
(43) Pub. Date: Nov. 20, 2003

(54) System and method for collecting information via the internet using existing web sites

(76) Inventor: Brian Wichman, Cedarburg, WI (US)

Correspondence Address: LATHROP & CLARK LLP, 740 REGENT STREET SUITE 400, P.O. BOX 1507, MADISON, WI, 537011507

(21) Appl. No.: 10/150,705

(22) Filed: May 17, 2002

(51) Int. Cl. G06F 17/60

(52) U.S. Cl. 705/40

(57) ABSTRACT

An information and payment collection system for enabling consumers to supply information or make bill payments to an organization or a company via the internet. A consumer uses a computer to access a home page at a web site for the organization or company. The consumer selects a payment link on the home page which transfers the consumer from the home page to a collection site at a different location from the web site of the company. The payment web site includes graphics and colors making it look like the consumer is still on the company web site. The consumer enters information or payment data on a transaction page displayed on the consumer's computer. The data is processed at the collection site and if the transaction is successful, a confirmation page, including a transaction number is displayed on the consumer's computer. In addition, an email is automatically created and sent to the consumer. The e-mail includes a link to the confirmation page and also includes the transaction number to facilitate the consumer dealing with customer service if necessary.

### BACKGROUND OF THE INVENTION

Field of the Invention

The present invention relates generally to electronic information and payment collection methods and systems, and more particularly to a method and system for collecting information and/or payments via the Internet using existing web sites of companies and/or organizations which are to collect the information or payments.

Electronic bill payment has evolved swiftly in the past several years, moving away from the necessity of a merchant, a service provider or a creditor sending hard copy bills to consumers. However, electronic bill payment systems have not gained widespread acceptance for several reasons. One reason is that most consumers are accustomed to receiving bills in hard copy form and paying the bills by check. Making payments to a bill payment service is far removed from making payment directly to the company that provided the consumer with goods and/or services. In this regard, most bill payment service bureaus are administered by credit card companies, banks, and the like, acting as agents for merchants, service providers or creditors. Thus, a consumer in making a payment to a bill payment service, loses association with the company which is to receive the payment.

Although many banks have online bill payment systems, such systems generally are tailored for payments to that bank, such as mortgage payments, bank loans, or deposits to checking or savings accounts, etc. Some utilities and corporations have entered the electronic bill payment arena. However, due to the large costs involved with establishing and maintaining the electronic bill payment systems, these systems are typically limited to very large utilities or corporations. Most smaller companies interested in converting to electronic bill payment must obtain the services of a bill payment organization.

A further consideration is electronic banking systems and/or payment collection systems, require advanced set-up or approval to process transactions. Generally, the advanced set-up is accomplished through a pre-authorization procedure which requires that the user provide personal and bank account information. This is particularly the case when the payment options which are available include ACH type payments. Typically, the consumer must complete and submit approval forms providing the information necessary to allow the bank or payment service to set-up the payment account before the consumer is allowed to make payments using this bill payment service. This approval time can take several weeks or longer. Moreover, payment service requiring pre-authorization provide very little control by the consumer over the withdrawal of funds from its bank account.

It is readily apparent that with current electronic bill payment systems, generally, there is no way to make last minute payment of a bill, such as a forgotten mortgage payment, payment of an insurance premium, or a payment on a revolving charge account any or all of which could result in cancellation, late fees and/or interest, for example.

In addition, electronic payment collection systems generally are limited to just that, collecting bill payments. Thus, known electronic payment collection systems are limited to certain types of companies, such as banks, merchants and utilities, for example. Such systems are not suitable for use in internet-based businesses, including small business concerns that operate out of a home, for example.

Another consideration is customer service, and the ability for a consumer to reconstruct payment or payments that have been made to allow the consumer to deal with customer service representatives of a company or organization in connection with a dispute relating to a payment that the consumer has made to the company or organization.

### SUMMARY OF THE INVENTION

The disadvantages and limitations of the background art discussed above are overcome by the present invention. With this invention, there is provided a method and system for collecting information and/or payments for an organization or company from a consumer via a computer network using an existing web page of the organization or company. The method and system comprise establishing a link between a computer of a consumer and a home page of the organization or company, transferring the consumer from the home page at the company web site to transaction pages at a collection site that is different from the company web site and displaying at least one transaction screen on the consumer's computer to allow the consumer to enter transaction data onto the transaction screen. The transaction data entered onto the transaction screen by the consumer is received and processed the transaction data at the collection site.

The information and payment collection system is applicable to a wide variety of applications and/or transactions (bill payments, entering subscriptions to magazines and the like, school enrollments, convention registrations) where entry of information to be collected is required.

In one embodiment, as a payment collection system, the payment transactions can be completed based upon a minimal amount of information entered by a consumer, allowing the consumer to quickly and easily make real-time payments. Advanced registration or approval is not required, allowing a consumer a last minute opportunity to pay a bill on or near the payment due date.

Moreover, the information and payment collection system is characterized by blendability to existing web sites, flexibility of application, low cost and ease and quickness of set up.

In one embodiment, when a consumer enters the web site of the company, the home page of the company includes a link to a transaction screen. The transaction screen prompts, the consumer to enter information relating to the transaction. In preferred embodiments of the present invention, this information is as abbreviated as is possible, thereby requiring only a minimal amount of information to be provided by the consumer regarding the basic parameters of the transaction. After the consumer has entered the transaction information, the consumer initiates the by selecting a “Payment” button on the payment page. The information entered by the consumer is then processed by the payment system.

### DESCRIPTION OF THE DRAWINGS

These and other advantages of the present invention are best understood with reference to the drawings, in which:

FIG. 1 is a functional schematic diagram of an internet information and payment collection system according to the present invention, which allows consumers to provide information and to make payments to companies and organizations by accessing existing web sites of the companies and organizations on the Internet;

FIG. 2 is a screen shot of a home page of a company which is accessed by a consumer for the purpose of making a payment or other transaction;

FIG. 3 is a screen shot of a Transaction page of the information collection system;

FIG. 4 is a screen shot of a Payment List page of the information collection system;

FIG. 5 is a screen shot of a Payment page and of the information collection system;

FIG. 6 is a screen shot of a Confirmation page generated in response to completion of a transaction using the information and payment collection system of the present invention;

FIG. 7 is a process flowchart outlining a preferred embodiment of the information collection system of the present invention, showing the site map;

FIG. 8 is a screen shot of an e-mail confirming completion of a transaction using the information and payment collection system of the present invention;

FIG. 9 a functional block diagram of the information and payment collection system illustrated in FIG. 1;

FIG. 9A illustrates features of a transaction page used in conducting transactions in the system of FIG. 1;

FIG. 9B illustrates features of a payment list page used in conducting transaction in the system of FIG. 1;

FIG. 9C illustrates features of a payment page used in conducting transaction in the system of FIG. 1;

FIG. 9D illustrates features of a confirmation page used in conducting transaction in the system of FIG. 1;

FIG. 10 is a simplified representation of a home page linked to an information page and multiple transaction pages;

FIG. 11 is a process flow chart for an authentication process of the information and payment collection system of the present invention;

FIG. 12 is a process flowchart showing the steps in a typical consumer's interaction with the information and payment collection system of the present invention, showing the steps through which the consumer can access a web site of a company and is linked to a transaction site for supplying information or making a payment;

FIG. 13 is a process flow chart for the transaction flow process for making an ACH payment in the information and payment collection system provided by the invention;

FIG. 14 is a process flow chart for one embodiment for an algorithmic calculation of the authentication process of FIG. 11;

FIG. 15 is a block diagram of customer service component/module of an administration site of the information and payment collection system of FIG. 1;

FIG. 16 is a screen shot of a Customer Service page;

FIG. 17 is a screen shot of a Consumer Transaction Search page;

FIG. 18 is a screen shot of a Consumer Transaction Search Results page;

FIG. 19 is a block diagram of the administration site of the information and payment collection system provided by the present invention;

FIG. 20 is a screen shot of a Main Screen Menu of the administration site;

FIG. 21 is a screen shot of a Page Manager Screen Menu of the administration site;

FIG. 22 is a process flow chart for a page edit component of the administration site;

FIG. 23 is a process flow chart for a download/report component of the administration site;

FIG. 24 is a block diagram illustrating components of the information and payment collection system provided by the present invention;

FIG. 25 is a simplified schematic illustration of hardware which can be used to implement the information and payment collection system of the present invention as depicted in FIG. 1, showing computers and modems used by consumers and companies; and

FIG. 26 is a simplified representation of a computer system of the information and payment collection system of FIG. 1.

### DETAILED DESCRIPTION OF THE PREFERRED EMBODIMENTS

General Description

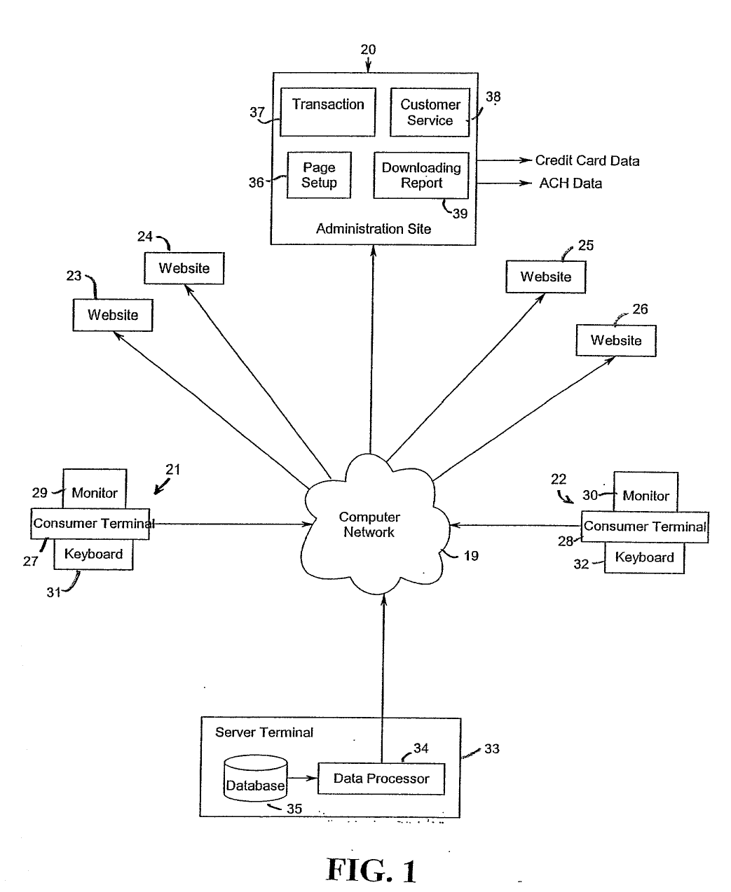

One preferred embodiment of an online information and payment collection system of the present invention is illustrated somewhat schematically in FIG. 1, which shows a number of elements which are coordinated so as to allow communication therebetween through a computer network such as the Internet 19. However, it will be appreciated by those skilled in the art that alternatives to using the internet as a communication medium can be substituted for the internet without departing from either the spirit or teachings of the information and payment collection system of the present invention. By way of illustration, the online information system according to the present invention is shown as including an administration or collection site 20, a plurality of consumer sites 21 and 22 and a plurality of on-line web sites 23, 24, 25 and 26 which are linked through the Internet 19. The information collection system enables a plurality of consumer sites, such as consumer sites 21 and 22, to communicate with web sites 23, 24, 25 and 26 of a plurality of companies or organizations, for example.

For purposes of illustration of the invention, the information and payment collection system is described with reference to an application as a payment collection system. However, the information and payment collection system of the present invention can be used in a wide variety of applications including collection of payments, donations, registrations, or a variety of other types of information. The types of payments can include parking tickets, mortgage payments, utility payments insurance payments, health co-payments, concentration, property tax bills, lease payments, annual dues, tuition payments, donations to charitable organizations, for example. In addition, the information and payment collection system can be used to collect information related to subscriptions to magazines, conference registrations, surveys, warranty registrations, or to respond to many other types of requests for information. Moreover, the information and payment collection system can be used in E-commerce applications, allowing a consumer to make online purchases. Thus, the term “company” as used herein is intended to encompass corporations; organizations, (both profit and non-profit organizations); donation recipients; schools, colleges and universities; city, state and federal governmental bodies, and any other entity that could be targeted as a recipient for a payment or for information such as that listed above, for example.

As will be shown, a submission to a company of information or of a payment (or making an online purchase) using the information and payment collection system of the present invention is carried out online using a payment or transaction page at the administration site 20. In one preferred embodiment, the payment or transaction page is linked to an existing web page of the company targeted to receive the information or payment. For example, the transaction page can be linked to the existing webpage of the company by way of menu options on the company home page. The transaction page is branded so that consumers believe that they are always supplying the transaction information directly to the company while entering information relating to the transaction. In accordance with one aspect of the invention, pre-registration is not required for consumers to make payment transactions using the payment collection system of the present invention.

Also shown in FIG. 1, the consumer sites 21 and 22 include consumer terminals 27 and 28, respectively, which are capable of communicating with the web sites 23, 24, 25 and 26. The consumer terminals 27 and 28 have monitors 29 and 30, respectively, on which the home page of an existing web site of a target company can be viewed, as well as transaction pages created by the information collection system of the present invention. The consumer terminals 27 and 28 also have keyboards 31 and 32, respectively, with which consumers at the terminals 27 and 28 may enter information and commands to effect bill payment using the payment collection system of the present invention. It will once be appreciated by those skilled in the art that there will be many more consumer terminals than the two consumer terminals illustrated in FIG. 1.

Access to and communication with the web sites 23, 24, 25 and 26 by the consumers is through the conventional web servers of the Internet, commonly referred to as a gateway computer, represented by terminal 33, and are substantially no different than communications by consumers accessing them on the Internet 19. The server terminal 33 can be of conventional design, and typically will utilize a data processor 34 and will access a database 35 in which information may be stored. The information which is stored in the database 35 can include software which controls the accessing by consumers of company web sites in the known manner.

However, in one preferred embodiment, the processing of transactions is carried out at the administration site 20 under the control of the company authorized administrator for the information and payment collection system. Stated in another way, a bank, financial institution, or the like establishes the information and payment collection system and provides and maintains the hardware and software at the administration site 20. However, once a company has become a subscriber of the information and payment collection system, an authorized representative(s) of the company is provided with access to programs and processes at the administration site 20, allowing that representative to perform administrative functions, including modifying transaction pages for the company, downloading transaction data, obtaining reports on transactions, and testing the company information and payment collection site, for example. In a further embodiment, a subscriber company can be provided with software packages allowing the collection processes to be hosted at a company site rather than at a centralized collection site, such as collection site 20.

The administration site 20 hosts a processing system operating under software control to allow creating of the transaction pages for subscriber companies, completing transactions initiated by consumers, and monitoring the collection of funds authorized through consumer transactions processed by the payment collection system. In one embodiment, the administration site 20 can be accessed by authorized representatives of subscriber companies using a uniform resource locator (URL) for the administration site 20. However, it will be appreciated by those skilled in the art that the manner in which the administration site is accessed is dependent upon communication medium used.

As will be described, using the existing web sites 23, 24, 25 and 26, the information and payment collection system of the present invention creates, for each company, an individual transaction or payment page which is linked to the existing web page of the company. The payment pages can be linked to the web pages via menu options on the home page. The payment pages are branded so that the consumers feel that they are always working with the company when entering their transactions. The payment pages can be blended in color, type and graphics with the web pages of the existing web sites.

The administration site 20 includes a page setup module 36, a transaction processing module 37, a consumer service module 38, and a downloading and report module 39. The page set-up module 36 allows an authorized representative of a subscriber company to create set of customized payment pages for the company. The page setup module 36 includes software programs accessible over the Internet, to allow a representative of the administrator for the information collection system, or preferably, one or more employees of the company, to create the format, style, etc. for the payment pages, such as the payment pages 42, 44, 46 and 48 illustrated in FIGS. 3-6, that are used in subsequent transactions. This includes selecting the amount and type of information that is required to be supplied by consumers as well as the layout of the payment pages (i.e. graphics, size and positioning of data entry boxes, prompts, action buttons, alphanumeric information, etc.). The page setup module 36 allows pages to be set up in a relatively short time, typically, from one to several hours, depending on the complexity of the page content. Moreover, the page setup module also allows the transaction pages to be modified when desired by the company.

The transaction processing module 37 controls the receipt of transaction information from consumers, including producing the payment pages in sequence to guide the consumer through a transaction, and the processing of the information to effect the transfer of funds from a consumer financial account to the company. The transaction processing module also maintains a record of the status of each transaction, and provides the consumer with transaction status reports on demand. The consumer can select a specific type of payment to be used to complete the transaction, such as payment by credit card or by an ACH type payment, for example. The transaction processing module 37 responds to process the payment including submission of the payment for approval by the consumer's credit card issuer or bank.

The customer service module 38 permits rapid handling of consumer inquiries. For example, automatic e-mail confirmations are sent to consumers once the transaction data has been submitted by the consumer. In one embodiment, the e-mail confirmations immediately provide the consumers with positive feedback on transactions and allow the consumers to monitor the transaction processing cycle. For example, the e-mail confirmation can include a hypertext link to a confirmation page which shows the status of the transaction and provides a reference or confirmation number for future use by the consumer if, for any reason, it becomes necessary for the consumer to contact customer service regarding the transaction. The e-mail confirmation, as well as the confirmation page, include information for enabling a consumer to contact a customer service representative of the company should that be necessary for any reason.

The downloading and report module 39 permits a company to download transactions and to obtain reports, including reports that show the number of hits on the web site and reports including statistical data relating to usage of the payment website for the company.

The payment collection system can provide daily reporting of the total credit card and/or ACH transactions that were created, indicating the credit that will appear on the company's account. This information can be included with the credit card information in the transaction summary report for each company. Transaction information can be downloaded by the company into a spreadsheet or uploaded into accounts receivable under the control of representatives of the company or can be produced as a hard copy report.

As is stated above, pre-registration is not required for consumers to make payment transactions using the payment collection system of the present invention. Thus, in accordance with another aspect of the invention, the payment collection system supports the use of online authenticating codes for validating blind transactions. The generation of the authenticating codes involves performing algorithmic calculations based upon information that is required to be supplied by a consumer making a blind payment. The algorithmic calculation links the transaction information, such as the amount of the payment, the invoice number, the customer's name or account number, and due date for the payment, etc. The authenticating code is included along with amount due, payment due date, etc., on the bill or invoice that is sent to the consumer. However, the information and payment collection system can process pre-authorized ACH transactions with a consumer submitting requested bank account and demographic information for approval in the manner known in the art.

Briefly, in preparing to make an online payment transaction using the payment collection system provided by the present invention, the consumer reviews the bill received from the company to which the payment is to be made to obtain information required to complete the payment transaction. The information the consumer can obtain from the bill typically includes the amount due, the consumer account number, the due date for the payment, and the authenticating code number, for example. In the example, the payment pages 42, 44, 46 and 48 are customized for collection of insurance premiums, and the payment information required on the Transaction page 42 includes policy number and amount due.

As the consumer enters the customer policy number and the amount of the payment online, the consumer is prompted subsequently for the authenticating code in a data entry box provided on the transaction page 42, and the consumer will enter that code if payment by ACH method is desired. The payment collection system then runs the same information, i.e., the customer policy number and the amount of payment through the algorithm and compares the result with authenticating code number that has been entered by the consumer. If the authenticating code number entered by the consumer matches the authenticating code number calculated by the system, the transaction is allowed to proceed. However if the authenticating code number entered by the consumer does not match the authenticating code number calculated by the system, the transaction is terminated and the consumer is directed to customer service.

Information and Payment Collection System

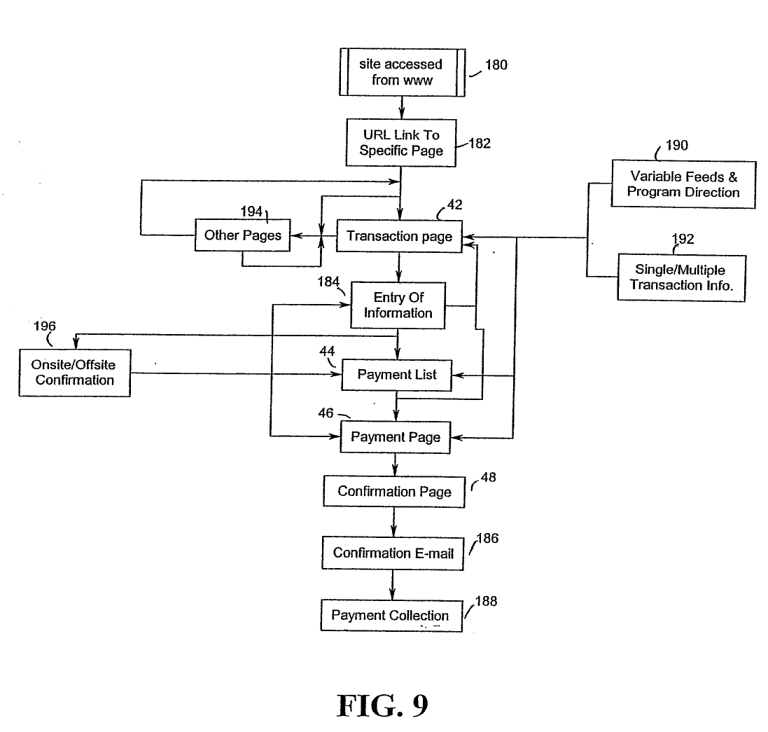

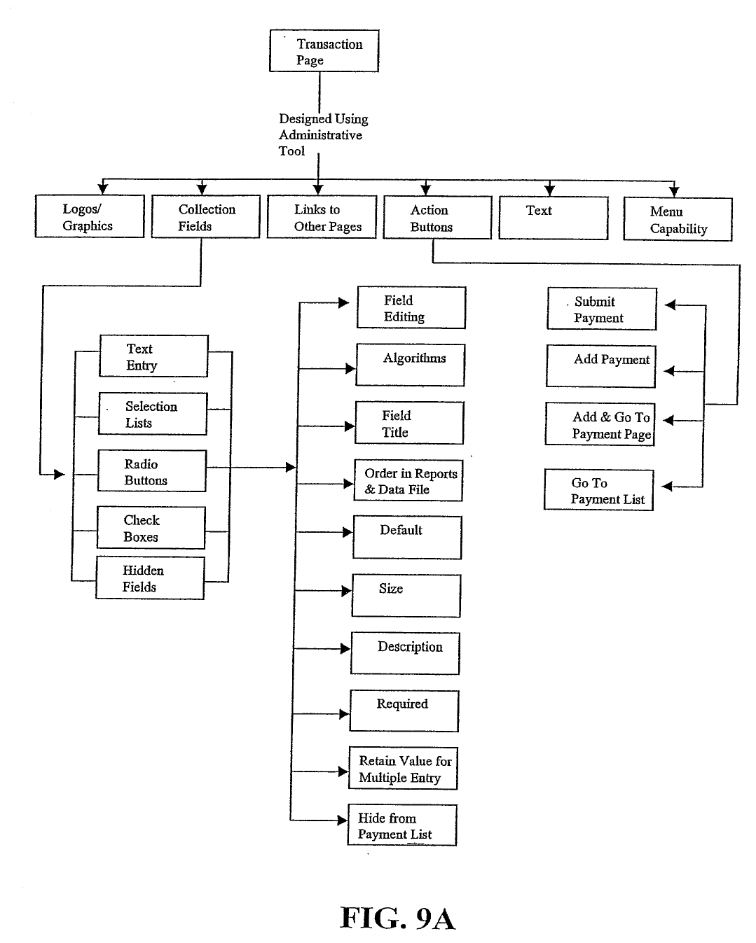

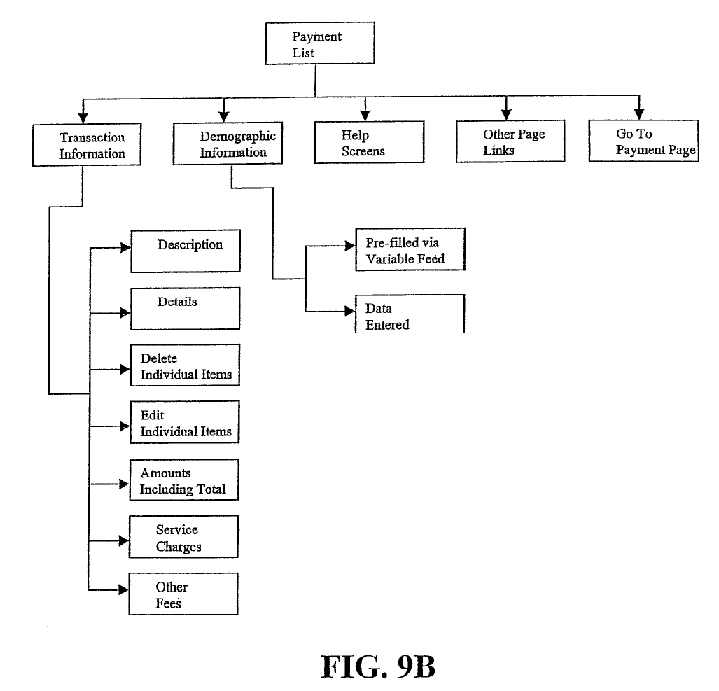

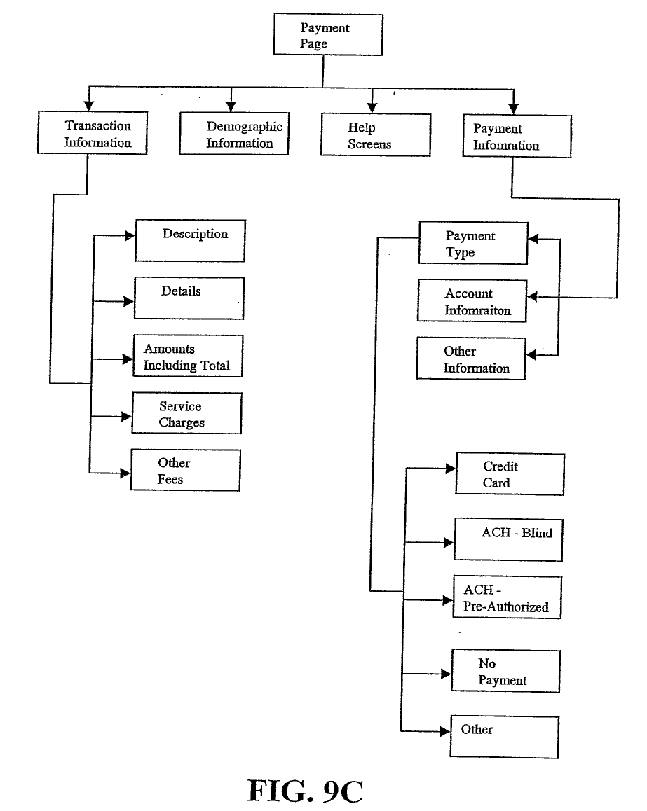

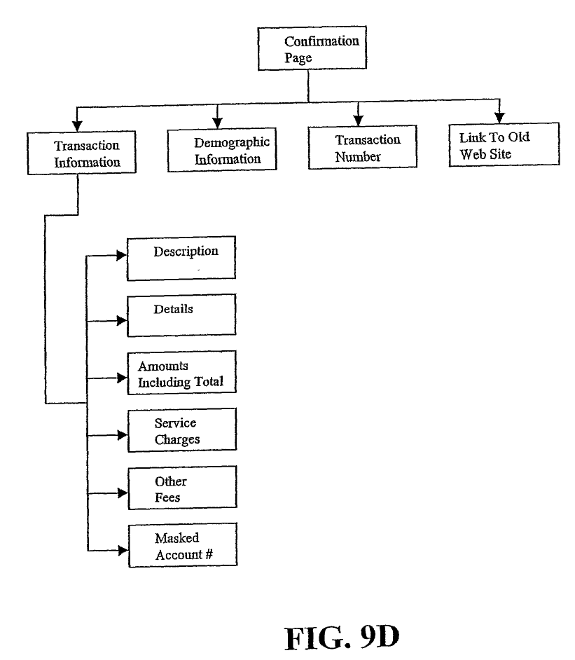

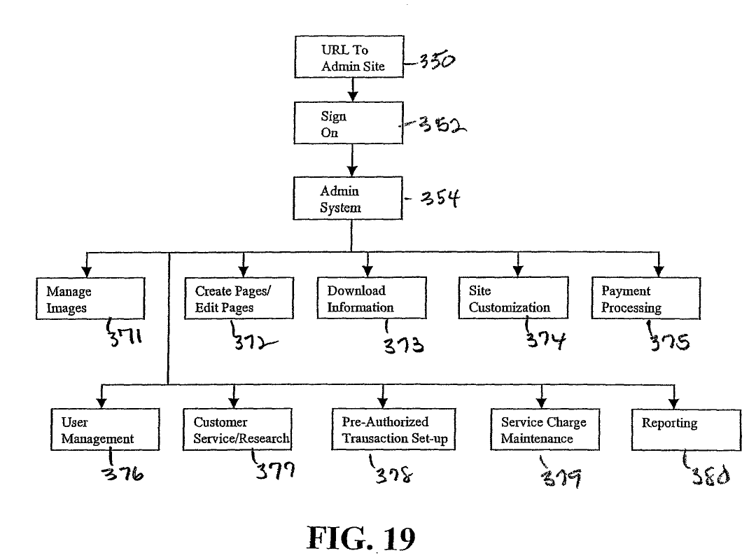

Referring to FIG. 9, there is shown a functional block diagram of the information and payment collection system provided by the present invention. The administration site 20 (FIG. 19) can be accessed through links, block 180, directly to a set of transaction pages created using tools (FIG. 19) contained at the administration site 20. The links can stand by themselves or can be called from an existing internet site via a menu, link or other way.

In one embodiment, the set of transaction pages includes a transaction page 42-, a payment list page 44, a payment page 46 and a confirmation page 48, which are presented to a consumer in that order, as shown in FIG. 9. As is described in detail herein, a typical transaction includes the entry by a consumer of information onto the payment pages, block 184, the submission of the payment to the system by consumer, the processing of the transaction by the payment system, and automatic notification of the consumer by the system as to the status of the transaction. The notification includes producing a confirmation page 48 which is displayed on the consumer's computer screen, and automatically sending a confirmation e-mail to the consumer, block 186. The payment system monitors payment collection, block 188 and can inform the consumer when a payment has been completed.

In another embodiment, the payment list screen is bypassed and the consumer is transferred directly from the transaction screen to the payment screen. Demographic information that is required to complete the transaction can be entered onto the transaction screen and/or provided by a variable feed function.

In accordance with a feature of the invention, information that is already known, such as information that had been obtained (and saved) from a previous transaction by the consumer, can be passed directly, or pre-filled, using a variable feed function, block 190, which can supply information directly to the transaction page 42, the payment list page 44 and/or the payment page 46. Moreover, block 192 can supply information for single or multiple transactions directly to the transaction page 42, the payment list page 44 and/or the payment page 46. For example, when a consumer is making two transactions, information, such as a customer account number, that is entered for the first transaction is saved and entered automatically into appropriate data fields of the transaction page 42, the payment list page 44 and/or the payment page 46 for the second transaction.

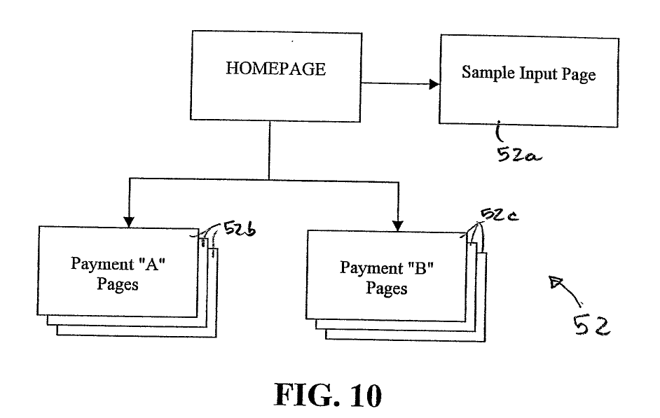

Moreover, the information and payment collection system can include other pages 52 (FIG. 10), block 194, which can supply to a consumer, additional information and/or instructions to facilitate the completion of the transaction by the consumer. These additional pages can be accessed directly through a URL link, block 182. Other pages 52a can provide additional information regarding the transaction. Moreover, a given company payment web site can provide for multiple transactions. For example, a municipal bill payment website can include a first set of transaction pages 52b customized to payment of water bills and a second set of transaction pages 52c customized to payment of parking tickets. The sets of transaction pages can be selected by a URL link provided on the home page of the municipal bill payment website. For example, for a set of transaction pages customized to payment of water bills, a consumer can go to one of the other pages to be instructed as to what information has to be captured from the bill for entry onto the transaction page. One of the other pages can display a copy of a parking ticket and demonstrate to the consumer what information should be entered on the transaction page in order to pay a parking ticket. The home page can include a first link to a first set of payment pages customized to payment of a water bill, and a second link to a second set of payment pages customized to payment of a parking ticket. Thus, a single information and payment collection website can have one or more sets of payment pages allowing payment of different bills, different types of bills and/or a combination of information collection and bill payment.

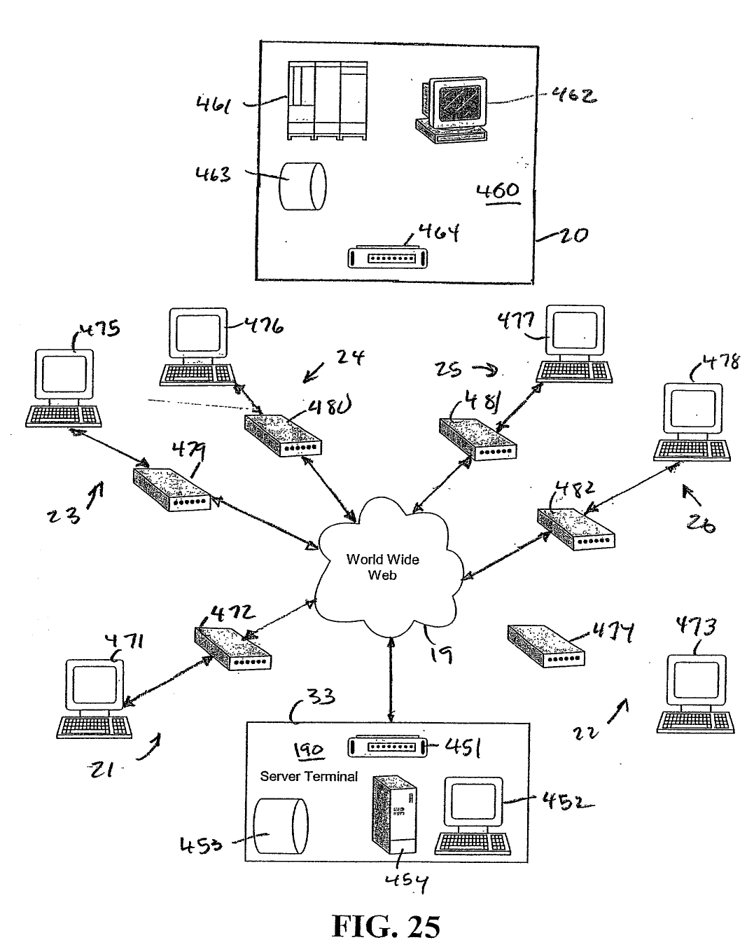

In addition, the information and payment collection system can include an onsite/offsite confirmation component, block 196, for confirming specific information, such as an invoice number, and the like, that is relevant to a transaction that is being processed. The confirmation component can access a database contained in data storage 463 (FIG. 25) at the administration site 20 of the information and payment collection system which stores consumer account information for the target company. Alternatively, the confirmation component can transmit, via the internet, a request to the target company for confirmation of specific information.

Home Page

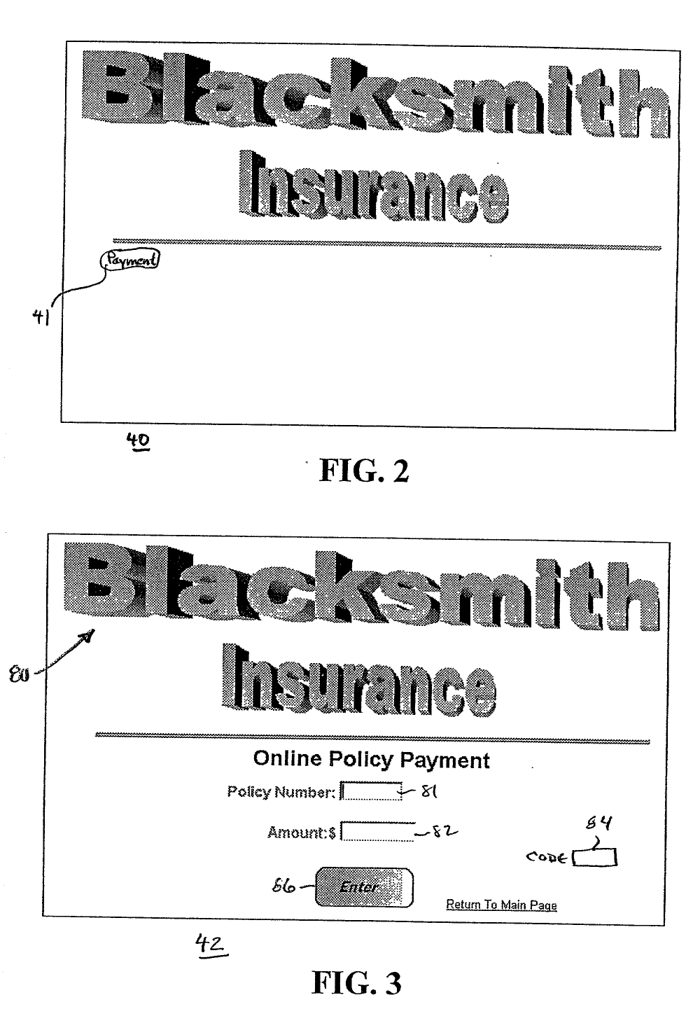

Considering the information and payment collection system in more detail, FIG. 2 is a screen shot of a home page 40 for a company for which online payments can made using the information and payment collection system of the present invention. The home page 40 is an existing web page for the company which has been modified to incorporate a link to the information and payment collection system of the present invention. In one embodiment, the link transfers a consumer to a transaction page 42 (FIG. 3) of the information and payment collection system. The link can be a hypertext text such as that indicated at “payment” 41 in FIG. 2, an action button, or any other type of link known in the art.

Briefly, a consumer making an online or internet payment will see four pages or screens during the course of a transaction. These pages include a Transaction page, a Payment List page, a Payment page, and a Confirmation page.

A screen shot of a Transaction page 42 is shown in FIG. 3. In one embodiment, the Transaction page 42 is the first page the consumer sees upon the selection from a company web site. However, the company web site can include a Welcome page (not shown) with link to the Transaction page 42 The Transaction page is used to collect important information of the transaction, such as customer identification or account number, invoice number or date, and the dollar amount for a payment being made. In the example, the Transaction page 42 collects policy number and payment amount. Alternatively, the information that is collected can be order information for a store or invoice for e-commerce transactions. In either case, the company determines what information is required to be entered onto the Transaction page.

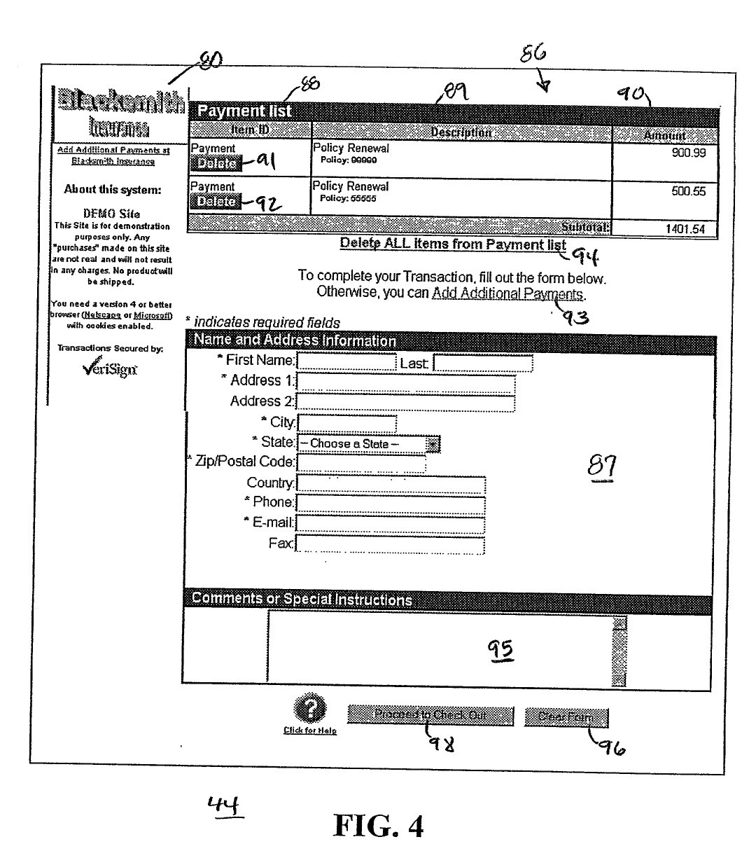

A screen shot of a Payment List page 44 is shown in FIG. 4. Referring to FIG. 4, the Payment List page, commonly referred to as a Shopping Cart, displays all of the transaction information in one location, it allows the consumer to verify the transactions and prompts the consumer to enter demographic information. The company determines what demographic information is required for the transaction. Shopping Cart is the internet term for a list of items submitted by a consumer. However, in payment applications, the shopping cart is referred to as a Payment list 44.

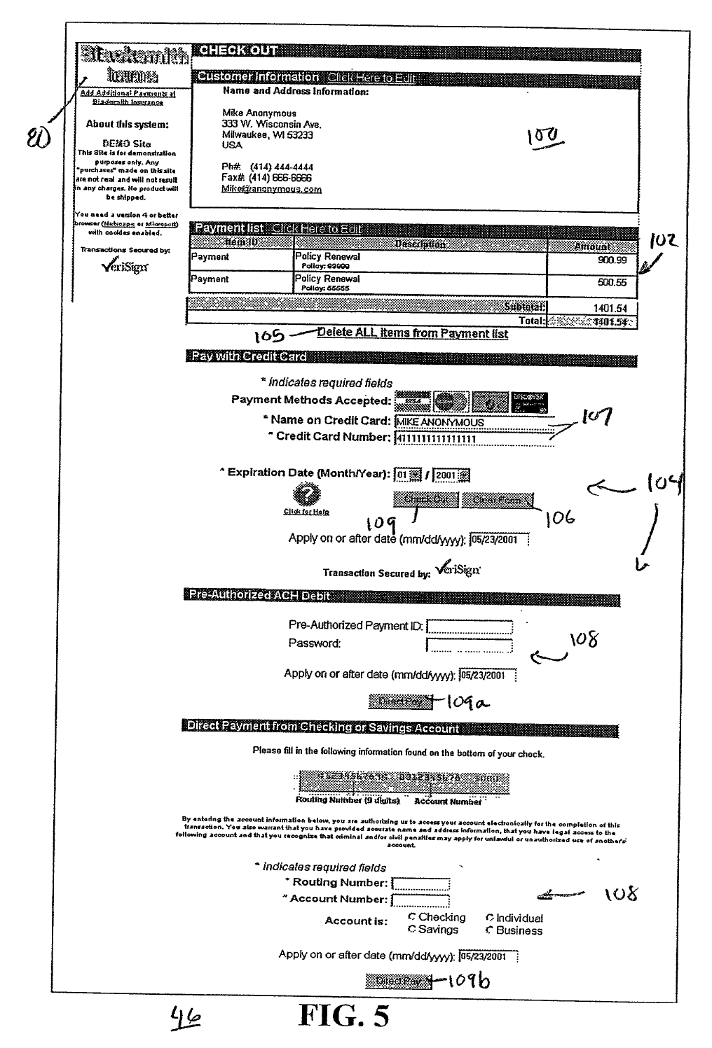

FIG. 5 is a screen shot of a Check Out or Payment page 46 and showing credit card and ACH payment options. The Payment page 46 displays the transaction and consumer information for review, and prompts the consumer to enter the information that is required for completing the payment transaction.

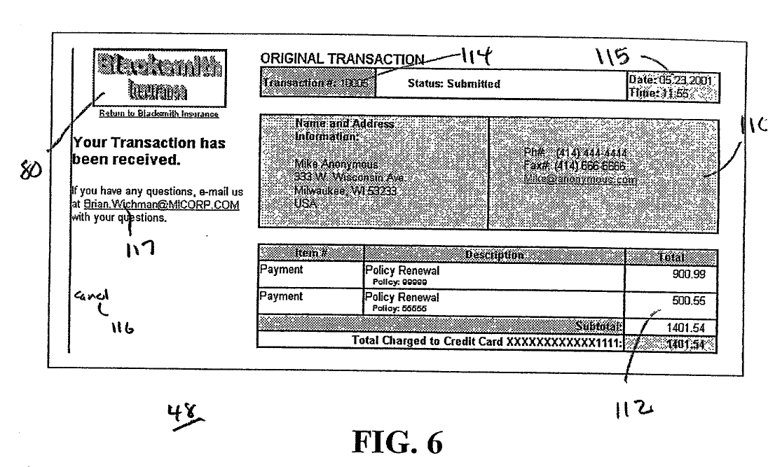

FIG. 6 is a screen shot of a Confirmation page 48. The Confirmation page 48, which is the last screen of the transaction, shows that the transaction has been initiated. The Confirmation page 48 also shows the status of the transaction and provides a reference or confirmation number for future use by the consumer.

Site Map

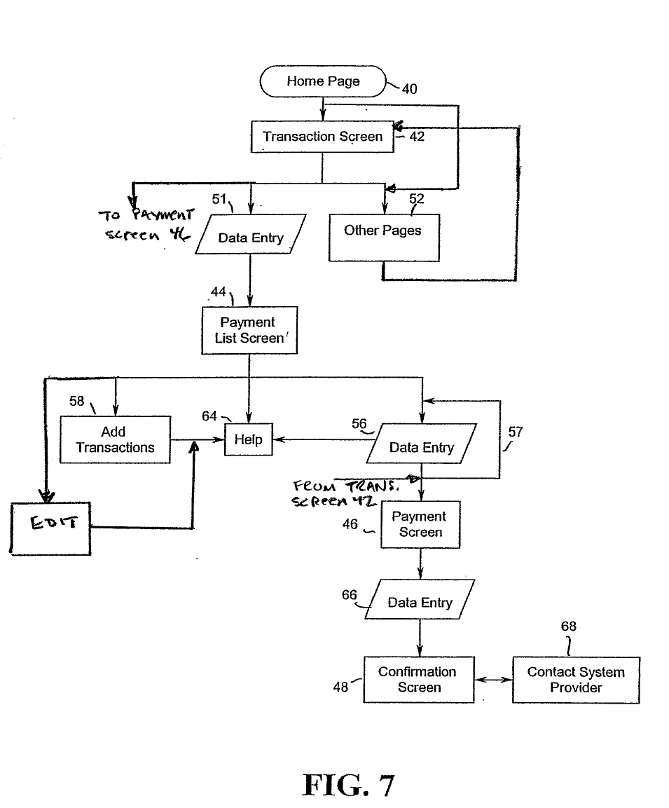

Referring to FIG. 7, a web site map for the preferred embodiment of the information and payment collection system of the present invention is illustrated, beginning with the Transaction page 42 which is accessed from the home page 40 of the company. The Transaction screen prompts the consumer to enter information relating to the payment being made. From the Transaction page 42, there are two options 51 and 52, of which the first is to a data entry step 51 in which the consumer enters the required data and causes the data to be transmitted to the payment collection system. Upon sending the data, the consumer will see the Payment List page 44.

The Payment List page 44 displays to the consumer a list of the payments that are being made, as instructed by the consumer. From the payment list page 44, the consumer has four options (other than going directly back to the transaction screen 42), of which the first is to go to a data entry step 56, in which in the preferred embodiment, the consumer enters the demographic data, such as name, address, telephone, for example. Multiple data entries are possible as is represented by loop 57.

Other options from the Payment List screen 44 are to add transactions 58 or edit transaction information 59, which will return the consumer to the Transaction screen. These options allow the consumer to enter data relating to a further transaction, or to modify transaction information previously entered. A fourth option is to go to a Help screen 64.

It is pointed out that the transaction screen 42 can provide for selection of the payment method (credit card or ACH), through which option, the consumer is transferred to the Payment screen 46.

Returning to the Payment List screen 44, once the required demographic information has been entered, the consumer can proceed with processing the transaction which brings up the Payment screen 46. From the payment screen, the consumer has two options (other than going back to the Payment List screen 44), of which the first is to select a payment method and enter the required data in data entry step 66 and cause the transaction to be completed. The second option is to go to the Help screen 64.

After entering the required information in the data entry step 66, the consumer can complete the transaction which causes the payments to be processed. From the data entry step 66, the Confirmation screen 48 is provided, indicating that the transaction has been completed. The Confirmation screen 48 has one option (other than returning to the home page 40), namely contact via e-mail 68 the company that administers the payment collection system.

Returning to the Transaction screen 42, the second option is to go to other pages 52. The information and payment collection system can include other pages which can supply to a consumer, additional information and/or instructions to facilitate the completion of the transaction by the consumer. The other pages 52 also can be accessed directly from the home page via links. Also, the other pages 52 can include a link for returning the consumer to the transaction screen 42.

Transaction Page

Referring again to FIG. 3, as has been stated above, the Transaction page 42 is the first page the consumer sees upon the selection from the homepage 40 of the company web site. The consumer goes to the company website and clicks on the payment button to bring the consumer to the transaction page. The Transaction page 42 is used to collect information relating to the transaction, such as customer number, invoice number, date of the invoice, the date payment is due, the dollar amount for a payment, or any other information that is important to the transaction.

In one embodiment, the Transaction page 42 includes a graphic 80 and color scheme which can be similar to or identical with those contained on the company home page 40. The Transaction page 42 includes a plurality of data entry boxes for receiving the required transaction data. In one embodiment, the Transaction page 42 includes two data entry boxes 81 and 82 to receive a consumer policy number and an amount due, respectively. In one embodiment, the Transaction page also includes a further data entry box 84 for receiving an authenticating code as will be described. Moreover, in one embodiment, the Transaction page 42 can include selection boxes or buttons to enable the consumer to select the payment method, i.e., credit card, Pre-Approved ACH payment or blind ACH payment, for example.

As is stated above, the company determines what payment information is required for payment transactions, and the Transaction page 42 is customized to include the data entry blocks, prompts, labels, etc. to obtain the required information from consumers. The company can quickly design and/or modify the payment pages, including the transaction page, a screen shot of which is shown in FIG. 3.

The consumer enters the payment information in the appropriate boxes 81, 82 and 84. After the consumer has entered the information relating to the payment, the consumer can accomplish the data entry step by selecting an “Enter” button 85 at the bottom of the Transaction page 42. This will take the consumer to the Payment List page 44.

FIG. 9A is a block diagram illustrating the features of a transaction page in accordance with one embodiment.

Payment List

Referring to FIG. 4, the Payment List page 44 displays all of the transaction information in one location. The Payment List page 44 corresponds to the Shopping Cart screen, the internet term commonly used in internet transactions for a list of items submitted by a consumer. In the payment application described herein, the “shopping cart” is referred to as a Payment list.

The Payment List page 44 allows the consumer to verify transactions which have been initiated by the consumer. The Payment List page 44 also displays prompts for demographic information, such as the consumer's name and address, and the consumer's e-mail address. The company determines what demographic information is required for payment transactions, and the Payment List page 44 is customized to include the data entry blocks, prompts, labels, etc. to obtain the required information from consumers.

Alternatively, demographic information can be fed from the home site or the transaction page. For pre-authorized transactions, the demographic information can be automatically fed from a database of the data storage 463 at the administration site 20 that has been pre-filled by a representative of the subscriber company.

The Payment List page 44 can include the same graphic 80 (although smaller in scale and relocated to the left margin), or different graphic, and color scheme as the home page 40 (and the Transaction page). The Payment List page 44 further includes a payment list 86, and a data entry field 87. The payment list is displayed on the Payment List page 44, the Payment page 46 and the Confirmation page 48, as will be shown.

In one embodiment, the payment list 86 includes the transaction information that was entered onto the Transaction page 42 by the consumer. The payment list includes an item column 88 which lists the recipient of the payment, a description column 89 which identifies the bill or invoice for which payment is being made, and an amount column 90 which contains the amount being paid. The payment list illustrated in FIG. 4 includes two rows because in the example, it is assumed that the consumer is making payments for two items or invoices. Each row of the payment list 86 can include a delete button, such as delete buttons 91 and 92, for each row in the item column 88, allowing the consumer to remove an item from the payment list 86. The Payment List page 44 can include an edit button allowing the consumer to change information that has been entered. In addition, the consumer can add additional transactions by selecting a hypertext link 93 to the Transaction page 42 or can delete all of the items from the payment list by selecting the “Delete All” link 94.

The data entry field 87 of the Payment List page 44 includes prompts for demographic information required to be supplied by the consumer. In the example, the consumer is prompted for name, address, telephone number and e-mail information. In addition, a comment box 95 allows the consumer to enter comments or special instructions. The consumer can clear the payment form by selecting the “Clear Form” button 96.

After the consumer has entered the required information into the boxes in data entry field 87, the consumer can accomplish the data entry step (or “check out”, in internet terms) by selecting a “Complete Transaction” button 98 at the bottom of the Payment List page 44. This will take the consumer to the Payment page 46. Alternatively, the consumer can clear the form by selecting the “Clear Form” button 99. The payment collection system can offer help locators on the Payment List page 44 and the Payment page 46. It is apparent from the screen shot 44 how the consumer can transfer to the Help screen 64.

Note that selecting action buttons 93 and 98 are used to jump to another screen and action buttons 91, 92, 94 and 96 are used to take the information and remain on the Payment List page 44.

FIG. 9B is a block diagram illustrating the features of a payment list page in accordance with one embodiment.

Payment Page

FIG. 5 is a screen shot of the Payment page 46 and showing credit card and ACH payment options. The Payment page 46 displays the transaction and consumer information for review. The Payment page 46 can include the graphics 80 and color scheme of the Payment List page 44 (and derived from the home page 40). The Payment page 46 further includes an information field 100 containing the demographic information entered by the consumer onto the Payment List page 44, along with the payment list 102, and data entry boxes 104 for receiving payment method information as prompted by the Payment page 46.

In one embodiment, the Payment page 46 allows the consumer to delete all items from the payment list by clicking on the hypertext link “Delete All Items” 105 and to clear the form by selecting a Clear button 106.

Referring to the data entry field 104, the consumer is offered options for methods of making the payment. In one embodiment, the payment options include credit cards and E-charge. The consumer can enter credit card information in blocks 107. The consumer is prompted to supply appropriate information to data boxes 107 on the Payment page 46. The company can select the payment methods that are accepted, and enables the selected payment methods on the Payment page. For example, the company can enable one or more of credit cards, such as Visa, Mastercard, American Express or Discover. Images of the credit cards accepted automatically appear on the Payment page 46. For ACH payments, either credit card or ACH type transactions can be enabled. The consumer can enter credit card information in blocks 107 or ACH information in blocks 108. The system accepts Pre-Authorized and blind ACH payments. In one embodiment, the consumer making a blind ACH payment is prompted to enter FRD/ABA information, such as the bank number, the consumer's bank account number and the type of checking account, i.e., business or personal. It is pointed out that payment types can be set individually by payment transaction screens.

The consumer can accomplish the data entry step, completing the transaction, by selecting a “Complete Transaction” button 109 for credit card payment, or “Direct Pay” buttons 109a, 109b for ACH payments. This causes the Confirmation page 48 to be displayed to the consumer. In one embodiment, an e-mail confirmation of the transaction is sent to the e-mail address that the consumer provided. It is apparent from the screen shot 46 how the consumer can transfer to the Help screen 64.

Note that selecting action button 109 is used to jump to another screen and action buttons 105 and 106 are used to take the information and remain on the Payment page 46.

FIG. 9C is a block diagram illustrating the features of a payment page in accordance with one embodiment.

Confirmation Page

FIG. 6 is a screen shot of the Confirmation page 48 which is generated upon completion of a transaction using the present invention. It is pointed out, by completion is meant that payment information has been received and is being processed for collection, and that approval of the payment by the paying institution, credit card company or bank, has been obtained. Typically, for credit card payment, this involves placing a hold on funds on the consumer's credit card account.

The Confirmation Page 48 is the last screen of the transaction. The Confirmation page 48 shows that the transaction has been initiated. The Confirmation page 48 also shows the status of the transaction and provides a reference or confirmation number 114 for future use by the consumer if, for any reason, it becomes necessary for the consumer to contact customer service regarding the transaction. It is pointed out that the confirmation page 48 is produced only after the transaction has been successfully completed, that is, after credit card (or ACH/NACHA) approval has been obtained.

In one embodiment, the Confirmation page 48 includes the graphics 80 and color scheme of the home page, a block 110 containing the consumer information entered on the Payment List page 44, and the payment list 112 that is contained on the Payment List page 44 and the Payment page 46. In addition, a transaction or confirmation number 114 is displayed near the top of the Confirmation page 48 along with the date 115 of the transaction. The Confirmation page 48 allows the consumer to cancel the payment by clicking on the “Cancel Payment” hypertext link at 116. The Confirmation page 48 contains an E-mail link 117 to the financial institution that administers the payment collection system.

FIG. 9D is a block diagram illustrating the features of a confirmation page in accordance with one embodiment.

In one embodiment, an E-mail is sent automatically to confirm that the transaction has been successfully processed and that payment has been submitted and is awaiting credit card charge or completion of NACHA processing. An e-mail is also sent automatically to indicate that the transaction has been cancelled for some reason, either by the consumer or by the company.

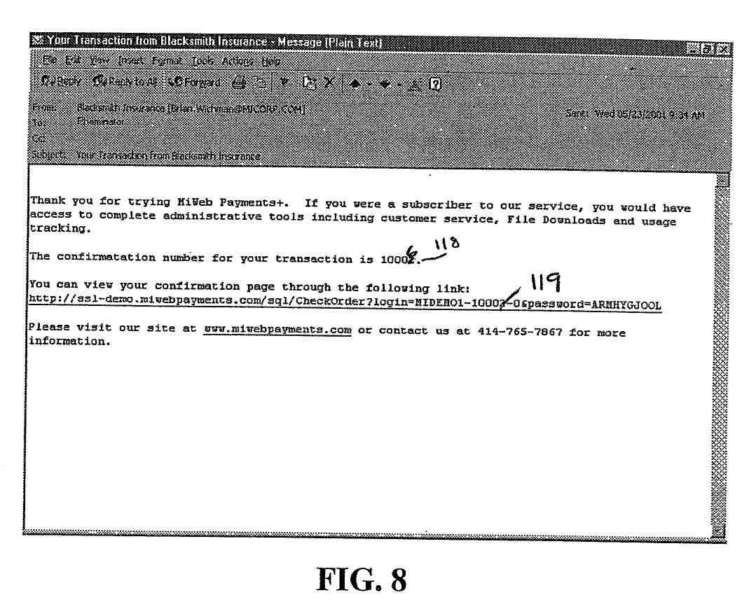

FIG. 8 is a screen shot of an e-mail confirming a payment that has been made. The e-mail confirmation includes the confirmation number or transaction number, indicated at 118, which the consumer can use, if necessary, to contact customer service of the company. In one embodiment, the e-mail confirmation message can include a hypertext link, indicated generally at 119, to the Confirmation page 48. The automatic e-mail confirmation immediately provides the consumer with positive feedback on the transaction and allows the consumer to monitor the processing cycle.

In one embodiment, the confirmation e-mail can also include the site name, the site e-mail address, the name of the consumer, the status of the transaction, the current date, and the URL of the web site, for example.

### Authentication Algorithm

Referring again to FIG. 3, as stated above, the transaction page 42 includes a data entry box 84 for receiving an authenticating code value. In one embodiment, for blind ACH transactions (and in some embodiments, also for credit card transactions), the value of the authenticating code is derived using some or all of the transaction information that is required to be entered by the consumer for that transaction, and in particular, the information that is entered into the data entry fields 81-83 on the transaction page 42. Depending upon the type of transaction information that the company requires a consumer to provide in making an on-line transaction, the transaction information can include both numeric and alphabetic characters. If the information includes alphabetic characters, each alphabetic character in each field is converted to a numeric value. Thus, each field comprises a multi-element component which can be expressed as a multi-digit number, representing a field numeric value. The field values are used in a calculation to produce the authenticating code. For example, the field numeric values for all of the required fields can be summed to obtain a total numeric value. It is pointed out that the resulting field numeric value for each data field can be multiplied by a common factor prior to summing the field numeric values to obtain a total numerical value.

The authenticating code is obtained from the results of the calculation. In one embodiment, selected digits of the total numeric value are used as the value of the authenticating code for that transaction. For example, the digits selected as the authenticating code can be the last digits of the total numeric value. If the number of digits of the authenticating code is less than a desired minimum number of digits, the result can be zero-filled. Moreover, the authenticating code can be alphanumeric, with alphabetic characters being interspersed with or added to selected numeric portions of the calculation result.

More specifically, in one embodiment, the value of the authenticating code is obtained in following manner, which is a non-limiting example of derivation of an authenticating code using transaction information.

### Step One

First, each field value involved in the algorithm is converted to a numeric value.

1. For text field (such as Customer Number, Invoice Number, etc.); each character is translated as follows:

Digits 1-9, retain their values and digit 0 is set equal to 10;

For alphabetic characters, A (and a)=1, B (and b)=2, C (and c)=3, etc. and the same constant K is added to each alphabetic character, where K is at least equal to 10.

All other characters are ignored.

Then, all the values of all the characters are summed to arrive at the field numeric value for that field.

2. Date field; the numeric value is a sequence of numbers as follows:

the four-digit year;

the month (1-12) and

the day (1-31) of the month are arranged in a string of numbers, in any order, i.e., year, month day or day, month year, etc. For example, the field numeric value for May 1, 2001 can be 05012001.

3. Money amount field; the decimal point can be ignored. Thus, the field numeric value for $125.00 is 12500.

### Step Two

Then, the field numeric values obtained for each field, the Text field, the Date field and the Money amount field, in the example, summed to produce a total numeric value.

### Step Three

The total numeric value can be left in decimal form and the last few digits are taken as the result of the algorithm.

The authenticating code value can be numeric or alphanumeric format. The number and types of fields used to calculate the authenticating code value can be determined by the company.

The authenticating algorithm that is used can be changed periodically to increase resistance to compromise. The change can be in processing parameters of the algorithm, such as the constant “K” used in converting alphabetic characters to numeric values. Alternatively or in addition, the change can be in the manner in which the algorithm is calculated. For example, for the date field the order of the numbers which form a string of numbers can be changed. For example, the sequence “month, day and year” can be changed to “day, month and year” or “year, month and day”.

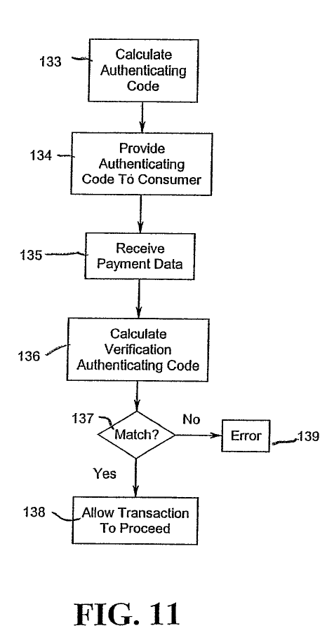

Referring to FIG. 11, there is shown a process flow chart for the authentication process according to the present invention. In block 133, an authentication code is calculated based upon information to be collected later from a consumer. In block 134, the authentication code is provided to the consumer. In one preferred embodiment, the authentication code is included in a bill or invoice that is provided to the consumer. The consumer can be instructed, either by information presented on the bill or otherwise provided to the consumer, to include the authentication code when making an online payment to the company. Thus, when the consumer is making the online payment, the consumer is prompted for the authentication code, block 135.

When payment information and the authentication code are entered onto the Transaction page by the consumer, the payment collection system calculates a verification authentication code, block 136, using some or all of the payment information being supplied by the consumer for the current transaction. The verification authenticating code is compared with the authenticating code entered by the consumer, block 137. The transaction is allowed to proceed, block 138, only if the authenticating code entered by the consumer matches the verification authenticating code. If the authenticating code entered by the consumer does not match the verification authenticating code, an error indication is produced, block 139, and the consumer is directed to customer service.

Consumer Action

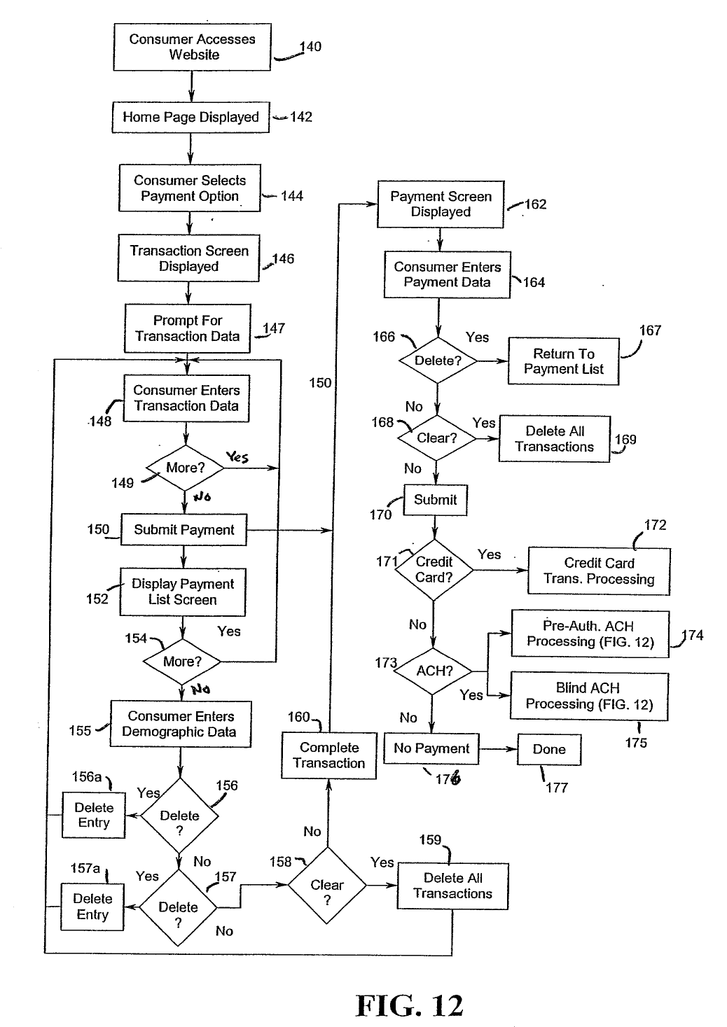

Reference is now made to FIG. 12 which is a flowchart showing the steps in a typical consumer's interaction with the system and method of the present invention. FIG. 12 illustrates the steps through which a consumer can authorize collection of a payment to a company by accessing the home page 40 of the company through the Internet 19 and be linked to the information and payment collection system from the accessed web site.

Referring to FIGS. 1, 2 and 12 the process starts at block 140 where the consumer enters the existing web site of the company, and the company's web site home page 40 is displayed at block 142. The consumer selects the payment option, block 144, by selecting the link 41 on the home page 40. This causes the Transaction page 42 (FIG. 3) to be displayed, block 146. Although not shown in FIG. 12, the consumer can access other pages, as described above, before or after accessing the Transaction page 42, to facilitate completion of the transaction.

Referring also to FIG. 3, the Transaction page 42 prompts the consumer for transaction information relating to the payment to be made, block 147. In the preferred embodiment of the present invention, the information that the consumer is required to enter is as abbreviated as is possible, thereby requiring only a minimal amount of information to be provided by the consumer regarding the transaction. In the example, the consumer is prompted for the customer number, the invoice number and the invoice amount, and the consumer enters the transaction data, block 148 In addition, the consumer can be prompted for the ACH validation code, allowing the consumer the option of making ACH type payment. Moreover, the Transaction page 42 can include selection boxes or buttons to enable the consumer to select the payment method, i.e., credit card, Pre-Approved ACH payment or blind ACH payment, for example.

As is stated above, in preparing to make an online payment transaction, the consumer reviews the bill received from the company to obtain the authenticating code number in addition to other payment information that the consumer may need to complete the payment transaction. Typical information useable in an on-line payment transaction includes the amount due, the consumer account number, the due date for the payment, and the authenticating code number, for example. In the example, the payment information is policy number and amount due. In generating the authenticating code number, the company ran selected transaction information through the authentication routine to determine the unique authentication code value. In the preferred embodiment, the information used in generating the authenticating number is the same information that the consumer is prompted to enter into data entry boxes 81-82 on the Transaction page 42.

As the consumer enters the policy number and the amount into the data entry boxes 81-82, the consumer is prompted to enter the authenticating code into data entry box 84. The transaction is allowed to proceed only if the number entered by the consumer matches a number calculated by the payment collection system. If the number entered by the consumer does not match the number calculated by the payment collection system, the consumer is directed to customer service. Decision block 149 determines if all transaction data has been entered. If not, flow returns to block 148.

After the consumer has entered the transaction data requested, block 148, flow proceeds from block 149 to block 150, and the consumer submits the transaction data, block 150, by selecting the pay invoice button 85. In one embodiment, this causes the Payment List page 44 (FIG. 4) to be displayed, block 152. Alternatively, the consumer can be transferred directly to the payment screen, block 162, if demographic information has been supplied by the variable feed function.

Referring to FIGS. 3 and 4, the consumer views the payment information that is included in the payment list 86. If one or more additional payments are to be entered, the consumer selects the Add Additional Transactions link 93. In one embodiment, decision block 154 returns the consumer to the Transaction page 42, which is blank because the transaction data has been transferred to the payment list. This allows the consumer to enter the additional transaction data.

In another embodiment, selection of the Add Additional Transactions link 93 maintains the consumer on the payment list page 86, but provides a further set of data entry boxes to allow the consumer to enter transaction data for a further transaction. It is pointed out that non-varying data, such as a consumer account number, can be maintained in a data entry field in response to the consumer selecting the Add Additional Transactions link 93, so that only variable data has to be entered. Thus, in this embodiment, the consumer has the ability to enter multiple transactions on the same screen.

Moreover, as described above with reference to FIG. 10, in some embodiments, a consumer is able to make multiple payments through accessing a single web site, the consumer having the option to select from a plurality of sets of payment pages (52b, 52c), with each set of payment pages being customized to a different type of payment, such as a water bill, a parking ticket, etc., for example. This type of multiple payment transaction can be carried out sequentially with the consumer completing one payment transaction and then accessing a further set of payment pages to conduct another transaction. Each set of payment pages can accept a different method of payment including one or more of the following payment methods, credit card, Pre-Authorized ACH, and blind ACH.

When the additional transaction data has been entered, the consumer selects the Enter button 85, transferring the additional transaction data to the payment list 86. This causes the Payment List page 44 to be displayed again, updated to include the additional transaction entered by the consumer. When no further transactions are to be entered by the consumer, flow proceeds from decision block 154 to block 155.

In addition to viewing the intended payment provided in the payment list 86, the consumer is prompted by block 155 for demographic data, such as the consumer's name, address, telephone number, e-mail, for example. In some embodiments, some or all of the demographic data can be supplied automatically by the information and payment collection system by way of the variable feed function which has been described. It is pointed out that while viewing the Payment List page 44, at any time prior to selecting a Proceed to Complete Transaction button 98, the consumer has the options of selectively deleting or editing one or more entries from the payment list, blocks 156, 156a, or 157, 157a, by selecting Delete buttons 91 and/or 92, or edit button 97, or deleting all transactions, blocks 158 and 159, by selecting clear form button 96. Block 159 returns the consumer to block 148.

When the consumer has entered the required data for all transactions intended, and the required demographic data, the consumer causes processing of the transaction to continue, block 160, by selecting the Proceed to Complete Transaction button 98.

This causes the Payment page 46 (FIG. 5) to be displayed, block 162. Referring also to FIG. 5, again, the consumer can view the payment information that is included in the payment list 102. In addition to viewing the intended payment provided in the payment list 102, the consumer is prompted, block 164, for payment data. For payment made by credit card, the consumer is prompted to enter the name on the credit card, the credit card number and the expiration date. For an ACH payment, the consumer is prompted to enter FRD/ABA information, such as the bank number, the consumer's bank account number and the type of checking account, such as business or personal, for example.

It is pointed out that while viewing the Payment page 44, at any time prior to selecting a Complete Transaction button 109, the consumer has the options of deleting entries, block 167 by returning to the payment list 44, and deleting all transaction information from the form, blocks 168 and 169, by selecting clear form button 106 When the consumer has entered the required payment information, the consumer by selecting the Complete Transaction button 109, causes processing of the total payment to be submitted for approval, block 170, either by the credit card company, blocks 171 and 172, when a credit card payment is being made or by the bank, blocks 173, 174 (Pre-Authorized ACH) and 175 (Blind transaction), when an ACH payment is being made. Certain information collection transactions have no payment associated with the transaction. This can be the case for subscriptions to magazines, conference registrations, surveys, warranty registrations, or response to any other type of request for information, for example. For such transactions, the transaction is terminated at blocks 176 and 177 after the information supplied by the consumer has been transmitted to the appropriate parties or transferred to a database.

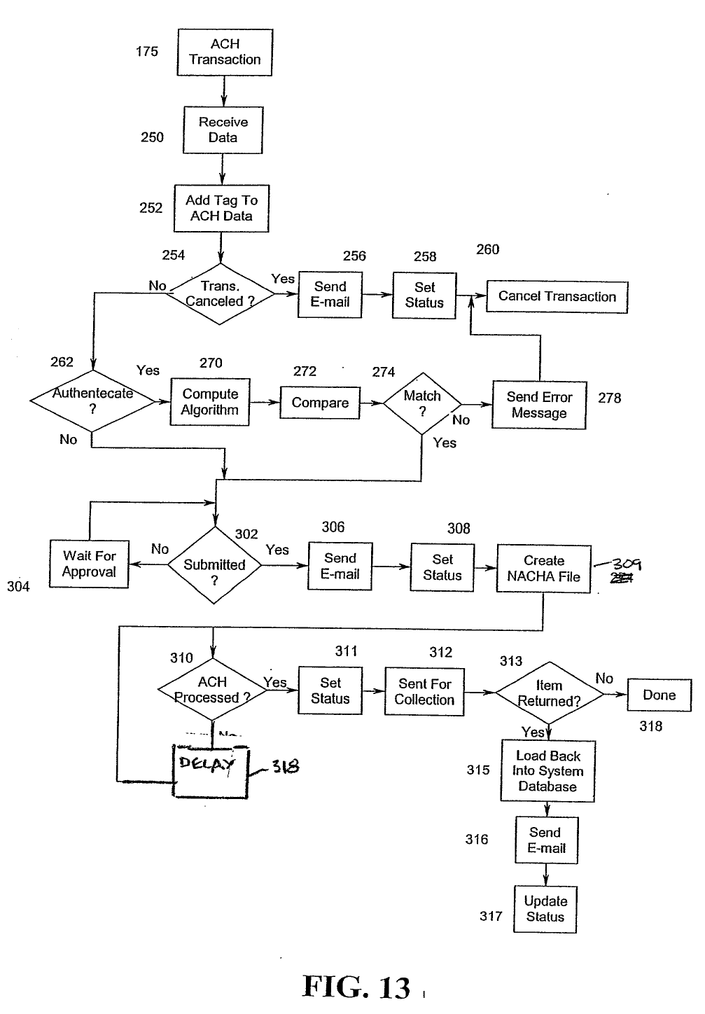

If decision block 171 determines that payment is being made by credit card, as indicated by the consumer having entered credit card information onto the payment page 46, block 172 provides credit card processing in the manner known in the art. If decision block 171 determines the payment is not being made by credit card, flow proceeds to decision block 173. If decision block 173 determines that an ACH type payment is being made, as indicated by the consumer having entered ACH information onto the payment page 46, block 174 (or block 175) provides ACH processing in accordance with the transaction flow shown in FIG. 13. Otherwise, no payment is being made block 176, and the transaction is done, block 177.

It is pointed out that the consumer can cancel one or more transactions at any time prior to submitting the transactions (block 170), by deleting the transactions or by clearing the form, and the consumer can cancel the payment prior to the transaction being captured, by using the transaction cancel link 116 on the confirmation page by accessing the Confirmation page 48 (FIG. 6).

Transaction Status for ACH Transactions

For transactions which involve ACH payment, the status of the transaction can be as follows: (1) submitted; (2) captured; (3) downloaded; (4) future date transaction; (5) returned; and (6) transaction cancelled. The statuses can be separated into pending (still in process) and concluded or done.

A tag is placed on each transaction entered by the payment process. As the status of the transaction changes, the tag is updated to reflect the change in status. Whenever a transaction is accessed, such as through the e-mail link by the consumer, the tag shows the current status of the transaction. This allows the consumer and the company to always know the status of the transaction in the processing system.

Submitted—A transaction with an approved authorization is given the status “Submitted” This appears at the top of the confirmation page 48. A transaction has been submitted. The payment is ready and will be captured the next time a capture routine is run. Entry level items can be downloaded and processed externally. An e-mail is sent to the consumer to confirm that the transaction has been successfully completed.

Captured—For ACH transactions, the transaction has been sent for collection. ACH transaction capturing can be done manually or automatically. If ACH transaction capturing is done automatically, the company can decide when and how often it is done.

Downloaded—Received transactions can be processed through the payment collection system or downloaded and processed outside of the system. If the transaction is downloaded, the transaction is given the status “Downloaded”, and the transaction is done. The capturing is done outside of the payment collection system. Transactions can be downloaded for later processing, or processing through a separate provider. Transactions are downloaded in batches which can be created based upon a number of days back, or a range of days. Each batch of transactions to be downloaded is assigned an attribute including a header and details related to the transaction. Transactions can also be downloaded with details based upon the status of the transactions. Information can be captured for a range of dates. The transaction data which is downloaded can be saved to a file or saved to a spreadsheet.

Returned—ACH transactions sent for collection are assumed to be captured. However, if a transaction is returned for any reason, the returned item is loaded back into the payment system database and matched with the original transaction. The status is changed to “Item Returned” and e-mail is sent to the consumer (with a blind copy to the company) informing the consumer that the payment has been denied.

Cancelled—The payment collection system allows for cancellation of a transaction after it has been submitted, but prior to being captured. The consumer can cancel a transaction by clicking on the “Cancel Transaction” button 116 (FIG. 6) on the Confirmation page 48. The payment collection system can cancel the transaction if approval is not obtained for the consumer's credit card issuer. In either case, the transaction is given the status “Cancelled”. An e-mail is sent to the consumer to confirm that the transaction has been cancelled.

Transaction Flow—ACH Payment

FIG. 13 is a process flow chart for the transaction flow for ACH payment processing. With reference to FIGS. 5 and 13, the ACH payment transaction 175 begins at block 250 which receives the transaction data, including the payment information contained in the payment list, the consumer demographic information entered on the Payment List page 44 and the ACH information entered on the Payment page 46. Block 252 adds the status tag to the transaction data for indicating the current status of the transaction.

Decision block 254 determines if the transaction has been cancelled. If so, block 258 updates the status to “Cancelled” by modifying the tag and an e-mail message is sent to the consumer, block 256, after the status is updated. The transaction is terminated at block 260.

If decision block 254 determines that the transaction has not been cancelled, flow proceeds to decision block 262 which determines if authentication is required. If decision block 262 determines that authentication is not required, flow proceeds to block 302 to submit the transaction.

If block 262 determines that authentication is required, blocks 270, 272 and 274 check the authenticating code that has been entered into the data entry box 84 to verify that the consumer is a person authorized to make the payment.

More specifically, block 270 calculates the algorithm using transaction data that has been entered into data entry boxes 81-83 of the transaction page.

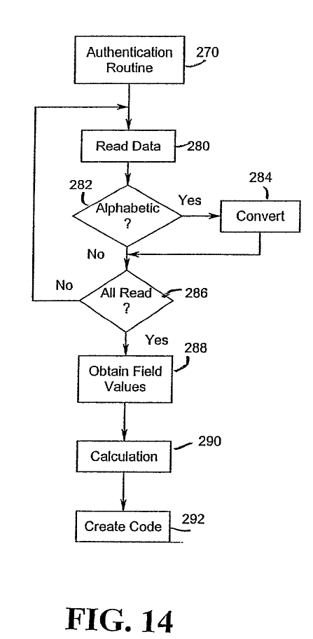

Referring to FIG. 14, there is shown a process flow chart for the calculation of the authenticating code value. Block 280 reads the transaction data that has been entered into data entry boxes 81-84. Blocks 282, 284 and 286 determine if there are any text fields. If so, block 284 converts the alphabetic characters to numerical values as described above. In the present example, the customer number invoice, the number and invoice amount, which have been entered in data entry boxes 81, 82 and 83, are all numerical values and so no conversion is required. Block 288 obtains the field numeric values for each of the three data fields. Block 290 performs a calculation using the field numeric values, such as summing the field numeric values, to arrive at the total numeric value.

Block 292 creates the code by selecting “N” digits of the final numeric value as the authenticating code, or for use in creating the authenticating code when alphabetic characters are incorporated into the authenticating code.

Referring again to FIG. 13, block 272 compares the authenticating number that the consumer has entered into data entry block 84 with the number that has been calculated in block 270 using the algorithm.

Decision block 274 determines if the value of the authenticating code entered by the consumer is the same as that calculated value. If the values match, flow proceeds to block 302. If the value of the authenticating code entered by the consumer does not match the value of the authenticating code calculated using the algorithm, flow proceeds to block 278 which refers the consumer to customer service.

It is pointed out that the calculation of the algorithm is a “server-side” check (i.e. the check is performed after the transaction has been submitted) rather than a JavaScript check as is done for required field checks.

Referring to block 302 which determines if the transaction has been approved. If approval has not yet been obtained, block 304 waits for the approval.

When approval is obtained, block 302 directs the flow to block 306 which completes the confirmation page, providing a confirmation number for the transaction. In addition, block 306 causes an e-mail to be sent to the consumer, preferably after the status has been updated, to inform the consumer that the transaction has been successfully completed. In one embodiment, the e-mail can provide the consumer with a link to the transaction confirmation page. Block 308 updates the status of the transaction to “Submitted”.

Referring to block 309, the payment collection system uses the information supplied by the consumer to generate an ACH file in the appropriate NACHA format to transmit payments initiated through the payment collection system. This includes the automatic creation of an “offset” transaction for each company that will pull/put the money in the appropriate account. The payment collection system can include dial-in FTP software for communication and transmission of the NACHA file to the bank. Daily there can be a file to download from the bank, including return items for prior day's ACH transactions. The return items are matched and used to update the database. A report of return items is created for viewing and/or downloading at the company location. This data file can include a notice of change transactions that can indicate a wrong account number or ABA number format. The FRD/ABA information can be retained for future transactions against the old FRD/ABA information.

When a NACHA file has been created for either a blind ACH transaction or a pre-authorized transaction, flow proceeds flow block 310.

Once the ACH transaction has been processed, block 310, the status is updated, block 311 and the transaction is sent to the consumer's bank for collection. If the payment is approved by the consumer's bank, as determined by block 313, the transaction is done, block 318. However, if the payment is returned by the consumer's bank, flow proceeds from block 313 to block 315 which loads the return item back into the database of the payment system and matches the transaction with the original transaction. An e-mail message is sent to the consumer, block 316, and a blind copy of the e-mail can be sent to the company. The status of the transaction is updated to “Item Returned” status, in block 317, preferably prior to sending the e-mail.

The payment collection system can support future dating of payments to an acceptable period. The transactions marked for future dating can be stored until a date specified by the consumer before the transaction is passed for collection. The “future date” for the transaction can be specified by the consumer as part of the payment information entered by the consumer onto the payment pages.

If block 310 determines that the ACH processing is not completed, such as for future date payment, flow proceeds to block 318 which provides a delay for the transaction to be captured. At the proper time the ACH processing is completed and flow proceeds from block 310 to block 311.

Customer Service

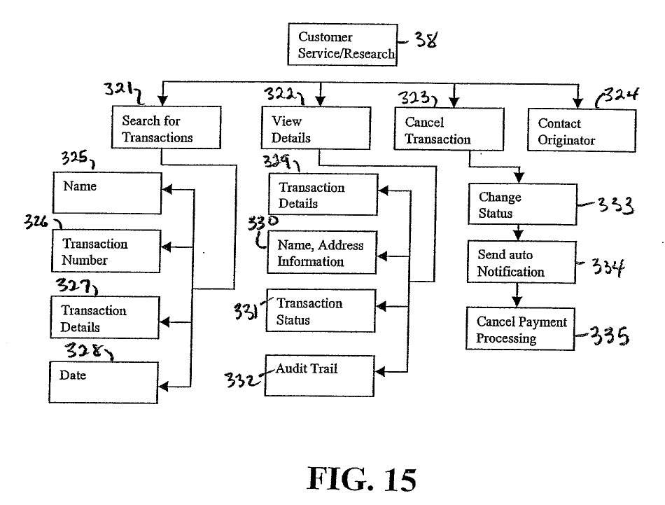

Referring to FIG. 15, there is shown a functional block diagram of the customer service module 38 of the information and payment collection system according to the invention. Briefly, the customer service module 38 can be subdivided into four functional categories, namely, search for transactions 321, view transaction details 322, functions relating to cancellation of a transaction 323, and the contacting of the consumer who originated a transaction 324.

More specifically, transactions can be searched by consumer name, block 325, transaction number, block 326, transaction details, block 327 or the date of the transactions, block 328.

The transaction details can be viewed on the basis of details of the transaction, block 329, name and address information for the consumer, block 330, the status of the transaction, block 331 and an audit trail, block 332.

As described above, when a transaction is submitted, the consumer receives an e-mail confirmation (FIG. 8). The Confirmation page 48 allows the consumer to determine the status of the transaction. In addition, the Confirmation page 48 is a useful tool for the consumer in dealing with the customer service of the financial institution should that become necessary. In one embodiment, the Confirmation page 48 can contain an E-mail link 117 to the company that administers the payment collection site and a link to the Confirmation page.

Once a transaction is initiated, i.e., the status of the transaction is “Submitted”, the status of the transaction is immediately available for view by customer service representatives. Every transaction is given a status upon entry. As the transaction is processed, that status is changed. The payment collection system can provide an online list of all transactions by status, or a specific transaction, or transactions, can be searched by a customer service representative for using values provided in certain fields.

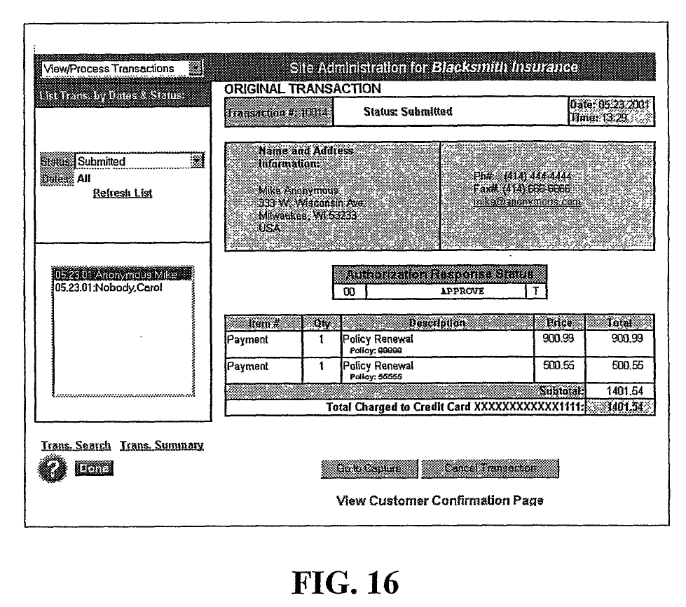

FIG. 16 is a screen shot of a Customer Service screen which allows a customer service representative to quickly sort items or transactions by status. This function is useful to a customer service representative in fielding an inquiry from a consumer.

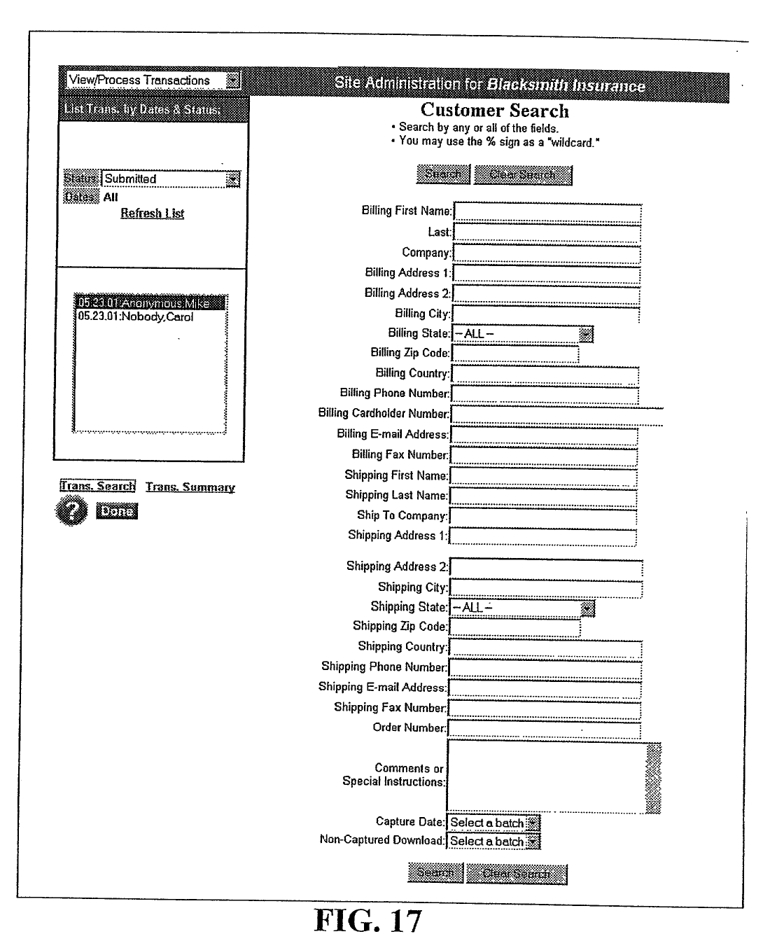

FIG. 17 illustrates a screen shot of a Customer Search screen which allows a customer service representative to search for a particular transaction. The customer service representative can conduct the search by entering information such as consumer name, address, or telephone number, or information pertaining the bill (or order).

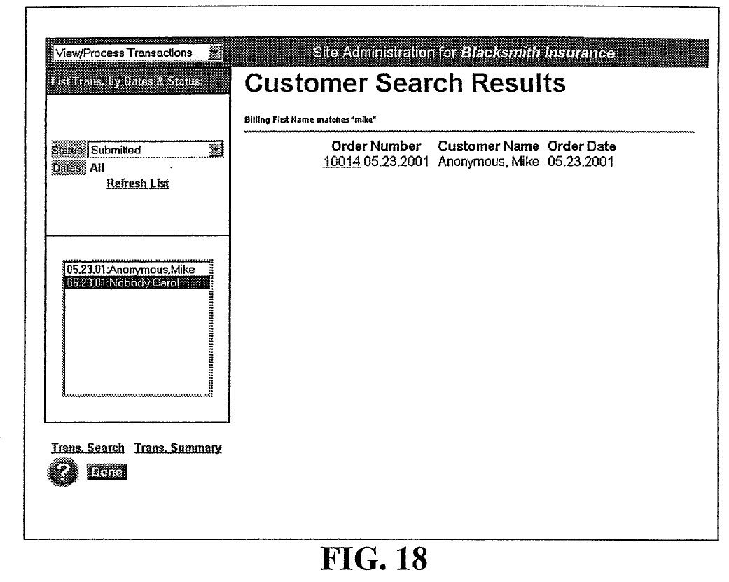

FIG. 18 is a screen shot of a Transaction Information screen which can be provided as the result of a status search (FIG. 17) or a search for a particular transaction (FIG. 18). The Transaction Information screen includes most of the information that was collected at the time the transaction was initiated. In addition, the Transaction Information screen includes a sequence or payment number which is the confirmation number for the transaction. The status of the transaction is indicated just to the right of the confirmation number on the screen. In one embodiment, the Transaction Information screen can provide a link, at the bottom of the screen, allowing the customer service representative to view the Confirmation page 48. The Transaction Information screen also includes a link to a transaction log which shows all of the details for credit card transactions.

The customer service representative also can cancel a transaction. Thus, a transaction can be cancelled by a consumer or by a customer service representative. In either case, the status of the transaction is updated, block 333, and a notification is sent automatically to the consumer who originated the transaction 334. In one embodiment, the notification is sent by e-mail. The customer service module 38 also oversees the processing of cancelled payments, block 335, which can include the notification of the consumer and the company.

The customer service module can also contact the originator of a transaction, or consumer, block 324 for any reason relating to transactions conducted by the consumer.

Administration Site

Referring to FIGS. 1 and 19, as described above, the administration site 20 of the payment collection system includes a page setup module 36, a transaction processing module 37, a consumer service module 38 and a downloading and report builder module 39.

The administration site 20 includes a multi-component software package, or tools which permit creation of customized transaction pages to initiate transactions, and processing of the transactions, including customer service for the duration of the transactions.

Referring to FIG. 19, there is shown a functional block diagram of the administration site 20 of the information and payment collection system according to the invention.

The administration site 20 can be accessed by authorized representatives of subscriber companies through a communication link, block 350. In one embodiment, subscriber companies can access the administration site 20 over the internet using the URL of the administration site, which is a password protected site requiring user login. An authorized company representative signs on, block 352, and is taken to the Main Menu of the administration site, block 354.

The administration site 20 provides for creating the payment screens, such as the Transaction screen 42, the handling of customer service, the downloading or uncaptured and captured transactions and the generation of daily payment reports for the subscriber companies and organizations. The administration site also provides for configuring the information and payment collection system for either payment collection or for E-commerce transactions for a given company web site. Access to page creation programs at the administration site 20 is password protected and requires pre-authorization by the administrator of the information and payment collection system.

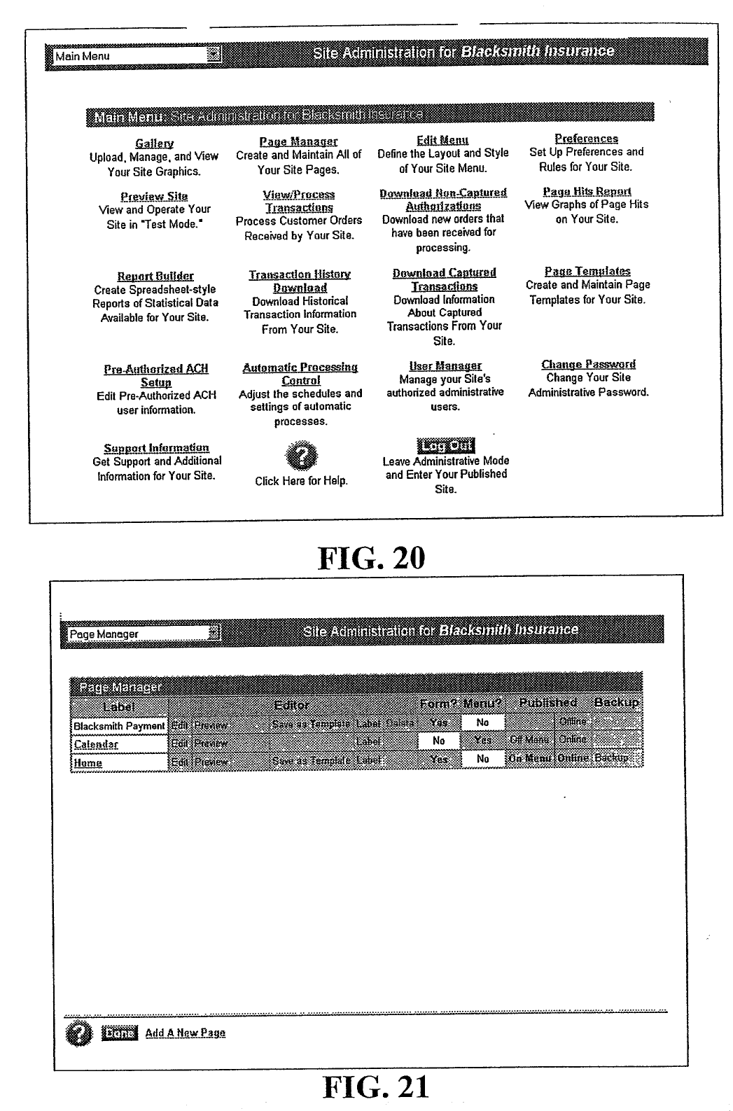

The administration site 20 includes a plurality of components, each of which is accessible from the Main Menu of administration site, a screen shot of which is shown in FIG. 20. These components control the setup and operation of each payment website, allowing the website for each subscriber company to be customized as to appearance and content of transaction pages, types of payment that are accepted, etc.

Briefly, a Manage Images component 371 allows downloading and use of personalized images for multiple functions throughout the website. This component permits the selection of graphics for use on a set of transaction or bill presentment pages that are being created for a company. Any image in “JPG” or “GIF” format can be used. Examples of graphics that can be used include a company logo, images of the bill and special button graphics. These types of graphics are useful in blending the payment pages with the rest of the existing web site of the company.

A Create Pages/Edit Pages component 372 allows a user to create multiple pages in the same administrative site. Each site can be accessed directly via the internet and remains independent from other pages in the site. A storage mechanism is automatically created in the data storage 463 at the administration site 20 to hold the transaction data. In addition, the Create Pages/Edit Pages component 372 provides for using stored data as a source of variable feed data at the time of accessing a page. The Create Pages/Edit Pages component allows adding to, or editing of pages, including selecting (or changing) colors, backgrounds, graphics, collection fields, links and actions. This includes automatically allocating appropriate storage to hold information captured during transaction entry (i.e. auto database management), including naming the field, setting characteristics, and performing edit checks. The collection fields can include text entry capability, selection lists, radio buttons, check boxes to facilitate entry of information.

Moreover, the Create Pages/Edit Pages component allows setting page characteristics such as valid payment types, title for the page, descriptions and establishing URL links. In addition, the Create Pages/Edit Pages component allows previewing and publishing a payment page or pages. A screen shot of a Page Manager screen is shown in FIG. 21.

A Download Information component 373 allows downloading of the most recent payments that have been received. This component provides transaction data in a data processing format for manipulation and processing. The components of the transaction file to be downloaded can be selected. The selected components can be retained for future downloads. The formats and/or delimiters of the download file can be selected. The selected formats and/or delimiters can be retained for further use. In addition, the file can be downloaded from the internet storage device of the information and payment collection system for use on other computers.

A Site Customization component 374 allows customization of non-transaction page specific areas. This includes the payment methods available, the payment list page 44, the payment page 46, the confirmation page 48, the contact messages going back to the initiator (or consumer) of the transaction and any help pages or links. Also, the Site Customization component allows a user to change label descriptions/status descriptions throughout a set of payment pages which comprises a payment web site, to supply an e-mail address for customer service questions, to select the required information for completing payment and to add graphics for the final payment screens. Moreover, the Site Customization component 374 also allows a user to specify e-mail language, payment methods which are accepted and to specify parameters for service fee management.

A Payment Processing component 375 processes the transactions and allows setting the types of payment that are accepted.

A User Management component 376 allows the website administrator for a subscriber company to set log-on ID's and to control access to the administration site. The User Management component enables the website administrator to shut off certain functionality selectively based upon user name, and to add users to the company's administrative website.

A Customer Service/Research component 377, as described above with reference to FIG. 15, allows searching for and viewing transactions on various criteria and automatic consumer notification in response to certain transaction status changes.

A Pre-Authorized ACH Transaction Set-up component 378 allows a company to permit consumers to obtain pre-approval for ACH transactions. The Pre-Authorized ACH Transaction Set-up component allows the use of variable feed data for satisfying some of the data entry requirements, particularly as to demographic information.

A Service Charge Maintenance component 379 allows the company to apply a service charge to transactions, including a flat fee or a fee based upon a predetermined percentage of a transaction payment.

A Reporting component 380 creates reports on the number of times the site has been visited and builds simple reports on statistical data on the web site.

Payment Page Creation

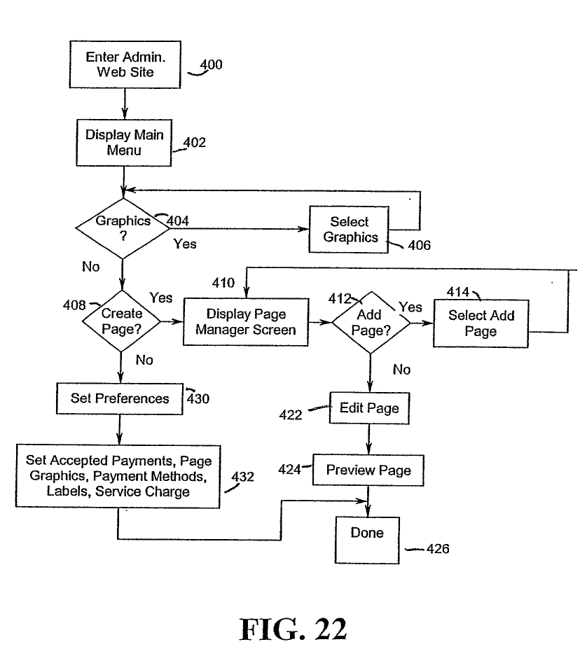

Referring to FIG. 22, there is shown a process flow chart for page management component. To create a payment page or set of payment pages, a user opens the internet Browser from a computer and establishes an internet connection to the administrative web site 20, block 400. The user views a site login screen at the administration site which prompts the user for a Login name and password. The user enters the Login name and password and clicks on a Login button. If Login is successful, the user is taken to the administration site Main Menu, shown in FIG. 20, which is displayed, block 402, on the screen of the user's computer. The user selects the components as necessary to accomplish creation of a set of payment pages.

Initially, a user can select images or graphics, block 404, to be included on one or more of the pages of the set of payment pages. causes the selected images to be displayed on the page being created.

Referring again to FIG. 20, to create or add a page, the user accesses “Page Manager” from the Main Menu. This causes the Page Manager screen to be displayed as shown in FIG. 21. In one embodiment, the Page Manager screen includes six sections “Label”, “Editor”, “Form”, “Menu”, “Published” and “Backup”.

The internet screens displayed are a series of pages housed on the system. A company can have as many pages as are needed.

Referring to FIG. 22, decision block 408 determines if the user is creating a payment site or adding a new page. If a page is being added (or edited), flow proceeds to block 410 which displays the Page Manager screen. Decision block 412 determines if a new page is being added or an existing page is being edited. If the user selects “Add a New Page” from the bottom of the menu of the Page Manager screen, f low proceeds to block 414. The user is prompted to enter a label for the new page.

The user is then returned to the Page Manager screen at block 410. At block 412, the flow is directed to block 422 to edit the page. The user can add form objects, text, etc. as desired.

Once a page has been created, the page can be edited. To edit a page, from Page Manager, the user selects “Edit” next to the page that is to be edited.

When the editing of the page has been completed, the user can preview the page, block 424. To preview the page that has been created, the user selects “Preview” under “Editor” on the Page Manager. “Preview” allows testing of changes without impacting the “live” site. To publish, or activate, the page, the user selects “Publish” under “Editor” on the Page Manager and the editing process is done, block 426.

Referring again to block 408, once a page or series of pages has been created, the user can set preferences, block 430, such as the type of payments that are accepted in the payment system for that company, i.e., credit card, blind ACH payments, or pre-authorized ACH payments, block 432. The preferences can also include page graphics to be used, labels, or service charges. For example, a flat fee or a percentage of the transaction amount can be added to the total payment for the transaction. When the preferences have been set, the process is done, block 426.

It is pointed out that feature labels can be customized as a function of application. For example, if collecting donations, use words such as Donor, Donation and Pledge on the payment pages. The information and payment collection system supports multiple pages. Each page has its own label. The label shows up on Page Manager, for example. A user creating a page is prompted for a label at the time the page is created.

Download/Report

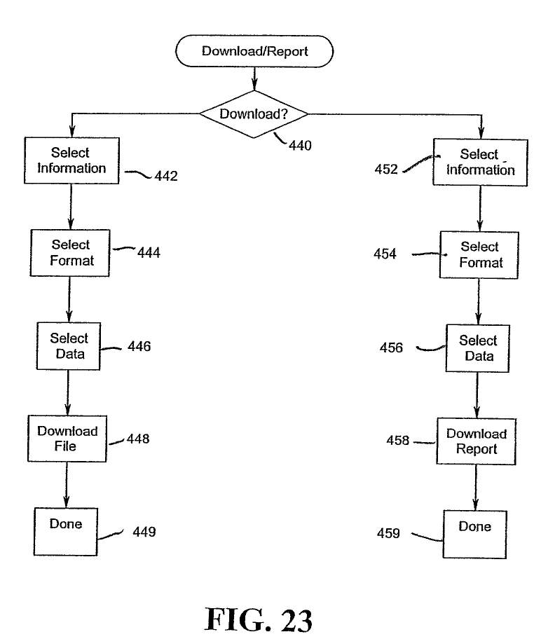

Referring to FIG. 23, there is shown a process flow chart for downloading of processed transaction data, and the generation of reports for the companies to summarize transactions that have been credited to the company accounts.

Decision block 440 determines if a download of transaction data or a report is requested. If a download of data is requested, block 442 selects the information for the download. Block 444 selects the format for the information. Block 446 select the specific transaction data to be downloaded. Block 448 downloads the data file.

If a report is requested, block 452 selects the information for the report. Block 454 selects the format for the report. Block 456 select the specific transaction data for inclusion in the report. Block 458 downloads the report. A transaction report can be produced for the company, in response to a request by an authorized representative of the company.

System Components

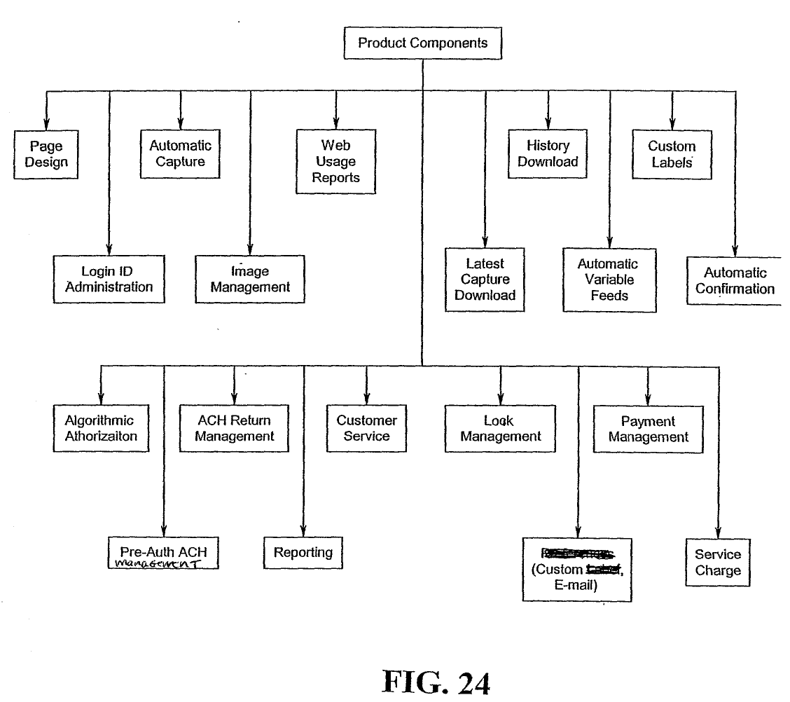

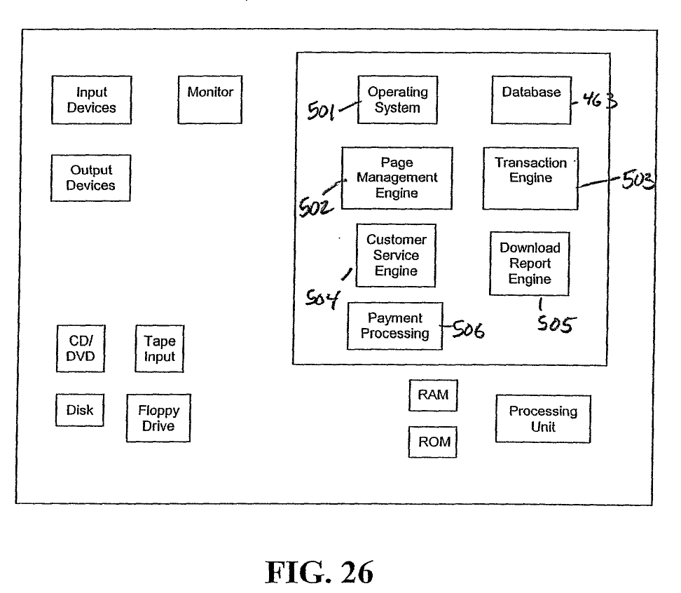

Referring to FIGS. 24 and 26, the payment collection system includes the following components. A page management engine 502 which includes page design, custom labels image management, custom e-mail, service charge and payment management components. A consumer transaction engine 503 which includes automatic variable feed, automatic confirmation, and algorithmic authentication components. A customer service engine 504 which includes a customer service component. A download/report engine 505 which includes history download, web usage report, latest capture download and reporting components. A payment processing module 506 which includes automatic capture, ACH return management and pre-authorized ACH management components.

Hardware

FIG. 25 is a simplified schematic illustration of hardware which may be used to implement the information collection system of the present invention as depicted in FIG. 1, showing computers and modems used by consumers (21, 22) and companies (23-26), computer and related equipment for the administration site 20, and the servers and modems of the server terminal 33 which provide interconnections between the consumers 21, 22 and the company web sites 23-26, and to the transaction component of the administration site 20 through the Internet 19.

In a manner similar to that of the illustration of FIG. 1, in FIG. 25, the online consumers 21-22, the companies 23-26, and the administration site 20 of the information collection system are all linked together in the preferred embodiment through the Internet 19.

The Internet communications interface 33 operates to connect an information collection system server to the Internet 19. The Web communications interface 33 can include suitable server hardware arrangement, as well known to those skilled in the art that can be used to interconnect consumers 21, 22 with web sites of the companies 23-26 via the Internet 19. The server arrangement can include a web communications interface 451 and a processor 452 operating under the control of software programs stored in data storage 452 to connect a server 454 to the Internet 19 for controlling connection of consumer terminals 21, 22 to the web sites 23-26 of a plurality of companies.

The administration site 20 of the information collection system can include a main frame computer system 460, including a mainframe computer 461, one or more terminals 462 and data storage 463, which can be coupled, on the one hand, by one or more modems 464 to the Internet 19, and, on the other hand, coupled by dedicated data communication links to financial institutions and the like, for communicating with such institutions in connection with payment processing. The data storage 463 can also store software implementing the methods and processes discussed herein, transaction information for subscriber companies, and transaction data generated as the result of transactions. The storage means 463 can include one or more hard disk drives, optical storage, or any other type of computer storage readily ascertainable to those skilled in the art.

Referring to FIG. 26, in one preferred embodiment, the information and payment collection system provided by the present invention, is software based and is capable of being executed in a computer system shown in block diagram form in FIG. 26. In one embodiment, the computer system includes input devices, such as a keyboard or mouse, output devices, such as a display unit with a screen, a printer, storage devices and a processing unit having associated random access memory (RAM) and read-only memory (ROM). Preferably, the computer system is a mainframe computer system can include a floppy drive, a tape input, a CD-ROM and/or DVD-ROM drive for receiving and storing information on computer readable media, such as CD-ROM or DVD-ROM disks. For example, the software programs which comprise the product components can be stored on any computer readable media including floppy disks, tape, CD-ROM disks, or DVD-ROM disks, for example.

In one embodiment, the storage devices include a database and software programs and files which are used in carrying out simulations of circuits and/or systems, including, in accordance with the invention. The programs and files of the computer system include an operating system 501, the page management engine 502, the consumer transaction engine 503, the customer service engine 504, the download/report engine 505 and, payment processing engine 506, for example. The programs and files of the computer system can also include or provide storage for transaction data, batch captured transaction data, payment pages for subscriber companies and organizations. The processor is connected through suitable input/output interfaces and internal peripheral interfaces (not shown) to the input devices, the output devices, the storage devices, etc., as is known.

As in FIG. 1, the information collection system illustrated in FIG. 25 shows two consumers and four companies connected thereto. It will be appreciated by those skilled in the art that there will be far more than two consumers and four companies in the actual system. Consumer 21 has a terminal 371 connectable through a modem 372 to the Internet 19. Consumer 22 has a terminal 373 connectable through a modem 374 to the Internet 19. In one embodiment, the hardware requirements for consumer terminals include for example, an IBM compatible processor having 10 megabytes of free space on a hard drive, 32 megabytes of memory; and the monitor is a VGA monitor which provides 256 colors or greater. The consumer processor preferably includes a Windows 95 or higher operating system and is connectable to the Internet by a Hayes compatible 56K modem. The consumer terminal has loaded thereon a web browser program such as Internet Explorer 4.0 or Netscape Navigator 4.0 or higher. Preferably, the consumer has an E-mail address.

The company web sites 23, 24, 25 and 26 include terminals 475, 476, 477 and 478, respectively which are connectable through modems 479, 480, 481 and 482, respectively, to the Internet 19. The information collection system does not require the installation of application software on the company machine. The information collection system uses existing internet explorer or Netscape browser and internet connection in establishing the initial connections between consumers and the existing web sites of the companies.

Although the system of the present invention has been shown and described with reference to particular embodiments and applications thereof, it will be apparent to those having ordinary skill in the art that a number of changes, modifications, or alterations to the invention as described herein may be made, none of which depart from the spirit or scope of the present invention. All such changes, modifications, and alterations should therefore be seen as being within the scope of the present invention.

What is claimed is:

1. A method for collecting information for an organization or company from a consumer via a computer network using an existing web page of the organization or company, said method comprising the steps of:
establishing a link between a computer of a consumer and a home page of the organization or company;
transferring the consumer from the home page at the company web site to transaction pages at a collection site that is different from the company web site;
displaying at least one transaction screen on the consumer's computer to allow the consumer to enter transaction data onto the transaction screen;
receiving the transaction data entered onto the transaction screen by the consumer;
processing the transaction data at the collection site.

2. The method as defined in claim 1, wherein said transaction pages include graphics and color scheme corresponding to graphics and a color scheme of the home page of the organization or company.

3. The method as defined in claim 1, wherein displaying transaction pages includes displaying in sequence, a transaction page, a payment list page, a payment page and a confirmation page.

4. The method as defined in claim 3, wherein the transaction data is non-payment information.

5. The method as defined in claim 3, wherein the transaction data is payment information.

6. A method for supplying transaction data to an organization or company via a computer network, said method comprising the steps of:
using a computer to access a home page at a web site for the organization or company;
displaying the home page on a monitor of the computer;
using the computer to select a link on the home page to transfer from the home page to a collection site that is different from the web site of the company;
displaying at least one transaction page at the collection site on the monitor of the computer;
entering the transaction data onto the transaction page for processing at the collection site;
processing the transaction data at the collection site;
producing a transaction identifying number for the transaction;
generating a confirmation communication including the transaction identifying number for the transaction; and
transmitting the confirmation communication to the computer via the computer network.

7. The method as defined in claim 6, wherein processing the transaction data includes producing a confirmation page indicating that the transaction has been successfully completed, and causing the confirmation page to be displayed on the monitor of the computer, wherein the confirmation page includes the transaction identifying number.

8. The method as defined in claim 7, wherein the confirmation communication includes a link to the confirmation page.

9. A method for collecting information for an organization or company from a consumer via a computer network using an existing web page of the organization or company, said method comprising the steps of:
establishing a link between a computer of a consumer and a home page of the organization or company;
transferring the consumer from the home page at the company web site to transaction pages at a collection site that is different from the company web site;
displaying a transaction screen on a display unit of said computer to allow the consumer to enter transaction data onto the transaction screen;
receiving the transaction data entered onto the transaction screen by the consumer and storing the transaction data in a data structure;
displaying a payment list screen on the display unit of said computer to allow the consumer to enter demographic information onto the transaction screen;
receiving the demographic information entered onto the transaction screen by the consumer and storing the demographic information data in a data structure;
displaying a payment screen on the display unit of said computer to allow the consumer to select a manner of payment;
processing the transaction data at the collection site using the demographic information and the selected manner of payment;
and when the processing of the transaction data is successfully completed, producing a confirmation page indicating that the transaction has been successfully completed; and
displaying the confirmation screen on the display unit of said computer.

10. The method as defined in claim 9, wherein including transferring the consumer from the home page at the company web site to an information providing page at a collection site, the information collecting page displaying information relating to the transaction being conducted.

11. The method as defined in claim 9, wherein transferring the consumer from the home page at the company web site to transaction pages at a collection site includes transferring the consumer to one set of a plurality of sets of transaction pages, each customized to collection of a different information.

12. A method for collecting information for an organization or company from a consumer via a computer network using an existing web page of the organization or company, said method comprising the steps of:
deriving an authenticating code using payment data to be submitted by the consumer in conducting a blind ACH transaction;
providing the consumer with the authenticating code along the payment data;
establishing a link between a computer of a consumer and a home page of the organization or company;
transferring the consumer from the home page at the company web site to transaction pages at a collection site that is different from the company web site;
displaying at least one transaction screen on the consumer's computer to allow the consumer to enter payment data and the authenticating code onto the transaction screen;
receiving the payment data and the authenticating code entered onto the transaction screen by the consumer;
processing the transaction data at the collection site;
wherein processing the transaction data includes responding to the receipt of the authenticating code submitted by the consumer to calculate a verification authenticating code using payment data corresponding to the payment data submitted by the consumer;
comparing the authenticating code submitted by the consumer with the verification authenticating code; and
allowing the ACH transaction to proceed only if the authenticating code entered by the consumer matches the verification authenticating code.

13. A method for validating a blind ACH transaction being conducted by a consumer in making a payment to a company or organization via a computer network, said method comprising the steps of:
deriving an authenticating code using payment data to be submitted by the consumer in conducting the blind ACH transaction;
providing the consumer with the authenticating code along the payment data;
receiving payment data and the authenticating code submitted by the consumer to a payment site via the computer network;
responding to the receipt of the authenticating code submitted by the consumer to calculate a verification authenticating code using payment data corresponding to the payment data submitted by the consumer;
comparing the authenticating code submitted by the consumer with the verification authenticating code; and
allowing the ACH transaction to proceed only if the authenticating code entered by the consumer matches the verification authenticating code.

14. The method as defined in claim 13, wherein deriving said authenticating code using payment data and calculating said verification authenticating code include running said payment data through an algorithm.

15. The method as defined in claim 13, wherein providing the consumer with the authenticating code includes providing the consumer with a hard copy of a bill which includes the authenticating code and the payment data.

16. The method as defined in claim 13, wherein deriving said authenticating code using payment data and calculating said verification authenticating code include running said payment data through an algorithm.

17. The method as defined in claim 14, wherein the payment data includes at least first and second multi-element components, and wherein running said payment data through an algorithm includes combining the elements of the first component to produce a first numeric value, combining the elements of the second component to produce a second numeric value, combining the first and second numeric values to produce a total numeric value, and selecting digits of the total numeric value as the value of the authenticating code.

18 An information and payment collection system for collecting information and payments for an organization or company from a consumer via a computer network using an existing web page of the organization or company, said system comprising:
a page management component for use in creating a set of transaction pages wherein the transaction pages have the look of the home page of the organization or company so that the consumer believes he is at the company web site,
and the page management component establishing a link between a computer of a consumer and a home page of the organization or company;
transferring the consumer from the home page at the company web site to transaction pages at a collection site that is different from the company web site;
a transaction component for displaying at least one transaction screen on the consumer's computer to allow the consumer to enter transaction data onto the transaction screen; the transaction component receiving the transaction data entered onto the transaction screen by the consumer and processing the transaction data at the collection site;
a customer service component for generating confirmation communications for transmission to the consumer to advise the consumer of the status of the transaction; and
a download component for downloading transaction after the transaction has been captured, the download component allowing an authorized representative of the company to obtain reports on transactions.

19 A system for collecting information and payment via a computer network, said system comprising:
a server terminal, operatively connected to the network;
at least one consumer terminal operatively connected to the computer network for sending to the server terminal information and payment regarding the via the computer network; and
a plurality of online terminals, operatively connected to the computer network, each associated with a different online company, said server terminal sending the information provided by a consumer to a selected online terminal via the computer network,
a collection site linked to the online terminal, the consumer being transferred from the online terminal to the collection site, the collection site producing a transaction screen which is displayed on the consumers computer to allow the consumer to enter transaction data.

20 A computer readable medium having instructions stored thereon for causing a computerized system to collect information and payments for an organization or company from a consumer via a computer network using an existing web page of the organization or company, said computer readable medium comprising:
a page management component for creating a set of transaction pages which have the look of the home page of the organization or company so that the consumer believes he is at the company web site,
and the page management component establishing a link between a computer of a consumer and a home page of the organization or company;
transferring the consumer from the home page at the company web site to transaction pages at a collection site that is different from the company web site;
a transaction component for displaying at least one transaction screen on the consumer's computer to allow the consumer to enter transaction data onto the transaction screen; the transaction component receiving the transaction data entered onto the transaction screen by the consumer and processing the transaction data at the collection site;
a customer service component for generating confirmation communications for transmission to the consumer to advise the consumer of the status of the transaction; and
a download component for downloading transaction after the transaction has been captured, the download component allowing an authorized representative of the company to obtain reports on transactions.
